(19) United States
(12) Patent Application Publication
(10) Pub. No.: US 2009/0288391 A1
(43) Pub. Date: Nov. 26, 2009

(54) CATALYST DETERIORATION DETECTION DEVICE

(76) Inventor: Keiichiro Aoki, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/306,265

(22) PCT Filed: Jun. 5, 2007
(86) PCT No.: PCT/JP2007/061354

§ 371 Date: Dec. 23, 2008

(30) Foreign Application Priority Data
Jun. 27, 2006 (JP) 2006-176822

(51) Int. Cl. F01N 11/00; F02D 41/18; F01N 3/20

(52) U.S. Cl. 60/273; 60/276; 123/704; 60/277

(57) ABSTRACT

The present invention detects the deterioration of a catalyst. In accordance with an output from an oxygen sensor, a catalyst deterioration detection device for the catalyst positioned in an exhaust path of an internal combustion engine detects a maximum oxygen storage state where an exhaust gas outflowing downstream of the catalyst contains excess oxygen and a minimum oxygen storage state where the exhaust gas outflowing downstream of the catalyst lacks oxygen. Control is exercised to provide a rich target air-fuel ratio for the internal combustion engine during an oxygen release period between the instant at which the maximum oxygen storage state is detected and the instant at which the minimum oxygen storage state is detected later, and to provide a lean target air-fuel ratio for the internal combustion engine during an oxygen storage period between the instant at which the minimum oxygen storage state is detected and the instant at which the maximum oxygen storage state is detected later. Further, the amount of oxygen released from the catalyst during the oxygen release period or the amount of oxygen stored by the catalyst during the oxygen storage period is detected as an oxygen storage amount. The deterioration of the catalyst is then judged in accordance with the oxygen storage amount. Moreover, when exercising control for catalyst deterioration detection, the catalyst deterioration detection device sets up oxygen storage amount detection conditions for correcting a variation that may occur in the oxygen release period or the oxygen storage period depending on a difference in output detection conditions for the oxygen sensor.

### TECHNICAL FIELD

The present invention relates to a catalyst deterioration detection device, and more particularly to a catalyst deterioration detection device for detecting the deterioration of a catalyst that purifies exhaust gas of an internal combustion engine.

### BACKGROUND ART

A catalyst for exhaust gas purification is positioned in an exhaust path of a vehicle-mounted internal combustion engine. The catalyst is capable of storing an appropriate amount of oxygen. If the exhaust gas to be purified by the catalyst contains HC, CO, and other unburned components, the oxygen stored by the catalyst oxidizes such unburned components. If, on the other hand, the exhaust gas contains NOx and other oxides, the catalyst reduces such oxides. The resulting oxygen is then stored in the catalyst.

The catalyst positioned in the exhaust path purifies the exhaust gas by oxidizing or reducing the components of the exhaust gas as described above. Thus, the purification capability of the catalyst greatly depends on its oxygen storage capability. Therefore, a decrease in the catalyst's purification capability, that is, the deterioration of the catalyst, can be judged by detecting the oxygen storage capacity of the catalyst, that is, the maximum amount of oxygen that can be stored by the catalyst.

A conventional device disclosed, for instance, in JP-A-2003-97334 detects the oxygen storage capacity of a catalyst installed in an exhaust path by forcibly making the air-fuel ratio of an air-fuel mixture supplied to an internal combustion engine fuel-rich or fuel-lean. While control is exercised to enrich the air-fuel ratio of the air-fuel mixture, the exhaust gas supplied to the catalyst contains HC, CO, and other unburned components lacking oxygen. When such an exhaust gas is supplied to the catalyst, the catalyst releases the stored oxygen to oxidize HC and CO for exhaust gas purification purposes. However, if this state continues for an extended period of time, the catalyst releases the entire oxygen and can no longer oxidize HC and CO. The resulting state is hereinafter referred to as the “minimum oxygen storage state.”

On the other hand, while control is exercised to enlean the air-fuel ratio of the air-fuel mixture, the exhaust gas supplied to the catalyst contains excess oxygen including NOx. When such an exhaust gas is supplied to the catalyst, the catalyst stores the excess oxygen in the exhaust gas to reduce NOx and the like for exhaust gas purification purposes. However, if this state continues for an extended period of time, the catalyst stores oxygen to its full oxygen storage capacity and can no longer reduce NOx and the like. The resulting state is hereinafter referred to as the “maximum oxygen storage state.”

The conventional device described above exercises control to provide a rich or lean air-fuel ratio for the air-fuel mixture so that the minimum oxygen storage state and maximum oxygen storage state repeatedly arise. This device determines the catalyst's oxygen storage capacity by determining the amount of oxygen stored by the catalyst during a transition from the minimum oxygen storage state to the maximum oxygen storage state or by determining the amount of oxygen released from the catalyst during a transition from the maximum oxygen storage state to the minimum oxygen storage state. Whether the catalyst is normal or deteriorated is judged by determining whether the oxygen storage capacity is larger than a predetermined judgment value.

Further, the timing for switching to a lean or rich air-fuel ratio according to air-fuel ratio forced control during the above-mentioned oxygen storage capacity detection is judged by detecting a change to a rich or lean air-fuel ratio of the exhaust gas discharged from the catalyst. More specifically, when the catalyst reaches the minimum oxygen storage state, the catalyst cannot oxidize rich components in the exhaust gas. Therefore, the exhaust gas discharged from the catalyst contains large amounts of HC and CO. As a result, the output of an oxygen sensor installed downstream of the catalyst changes to indicate that the air-fuel ratio is fuel-rich. When, on the other hand, the catalyst reaches the maximum oxygen storage state, the catalyst cannot reduce lean components in the exhaust gas. Therefore, the exhaust gas discharged from the catalyst contains a large amount of NOx. As a result, the output of the oxygen sensor installed downstream of the catalyst changes to indicate that the air-fuel ratio is fuel-lean.

Consequently, when the oxygen sensor output changes to a value indicating that the air-fuel ratio is lean or rich, it can be concluded that the catalyst has reached the maximum or minimum oxygen storage state. Therefore, when the output of the oxygen sensor installed downstream of the catalyst changes to a lean or rich air-fuel ratio, the conventional device described above concludes that the timing for air-fuel ratio switching has arrived, and switches to a rich or lean air-fuel ratio for control purposes.

[Patent Document 1]: JP-A-2003-97334

### DISCLOSURE OF INVENTION

### Problem to be Solved by the Invention

The output response of the oxygen sensor varies depending on the flow rate and flow velocity of the exhaust gas, the temperature of the exhaust gas, the temperature of a sensor element of the oxygen sensor, the deterioration of the oxygen sensor itself, and various other conditions. Therefore, even if the exhaust gas concentration prevailing downstream of the catalyst changes to be lean or rich with the same timing, the timing with which the oxygen sensor accordingly generates an output to indicate leanness or richness varies depending on the above-mentioned detection state conditions. Since the maximum or minimum oxygen storage state is detected when the oxygen sensor generates an output to indicate leanness or richness, the variation in the output response of the oxygen sensor varies the timing with which the maximum or minimum oxygen storage state is detected.

The conventional device described above computes the oxygen storage capacity in accordance with the amount of stored or released oxygen (oxygen storage amount) during a transition between the maximum oxygen storage state and minimum oxygen storage state. Therefore, if the maximum or minimum oxygen storage state detection timing varies depending on the detection conditions, the oxygen storage amount and the oxygen storage capacity computed according to the oxygen storage amount vary. If the above-mentioned variation in the oxygen storage capacity increases, it is conceivable that the accuracy of catalyst deterioration detection based on the oxygen storage capacity may decrease. For an increase in the accuracy of catalyst deterioration detection, it is therefore desirable that the oxygen storage capacity be detected with increased accuracy by preventing the oxygen storage capacity from varying with the detection conditions.

The present invention has been made to solve the above problem. An object of the present invention is to provide an improved catalyst deterioration detecting device that is capable of computing the oxygen storage capacity with increased precision and detecting the deterioration of a catalyst with increased accuracy even when the output detection conditions for an oxygen sensor vary.

### Means for Solving the Problem

In accomplishing the above object, according to a first aspect of the present invention, there is provided a catalyst deterioration detection device including: a catalyst which is positioned in an exhaust path of an internal combustion engine; an oxygen sensor which is positioned downstream of the catalyst; maximum oxygen storage state detection means which detects, in accordance with an output from the oxygen sensor, a maximum oxygen storage state where an exhaust gas outflowing downstream of the catalyst contains excess oxygen; minimum oxygen storage state detection means which detects, in accordance with the output from the oxygen sensor, a minimum oxygen storage state where the exhaust gas outflowing downstream of the catalyst lacks oxygen; rich air-fuel ratio control means which exercises control to provide a rich target air-fuel ratio for the internal combustion engine during an oxygen release period from the instant at which the maximum oxygen storage state is detected to the instant at which the minimum oxygen storage state is detected later; lean air-fuel ratio control means which exercises control to provide a lean target air-fuel ratio for the internal combustion engine during an oxygen storage period from the instant at which the minimum oxygen storage state is detected to the instant at which the maximum oxygen storage state is detected later; oxygen storage amount detection means which detects the amount of oxygen released from the catalyst during the oxygen release period or the amount of oxygen stored by the catalyst during the oxygen storage period as an oxygen storage amount; catalyst deterioration judgment means which judges the deterioration of the catalyst in accordance with the oxygen storage amount; and oxygen storage amount detection condition setup means which sets up oxygen storage amount detection conditions for correcting a variation that may occur in the oxygen release period or the oxygen storage period depending on a difference in output detection conditions for the oxygen sensor.

According to a second aspect of the present invention, there is provided the catalyst deterioration detection device as described in the first aspect, further including intake air amount detection means which detects the amount of intake air that is taken into the internal combustion engine; wherein the oxygen storage amount detection condition setup means includes: change amount computation means which computes, in accordance with the intake air amount, an air-fuel ratio change amount that is required for changing the current air-fuel ratio to the rich target air-fuel ratio or the lean target air-fuel ratio when control is exercised during the oxygen release period or the oxygen storage period to change the air-fuel ratio of the internal combustion engine to the rich target air-fuel ratio or the lean target air-fuel ratio; rich air-fuel ratio judgment means which judges, during the oxygen release period, whether a rich air-fuel ratio obtained by subtracting the air-fuel ratio change amount from the current target air-fuel ratio is greater than the rich target air-fuel ratio; rich air-fuel ratio setup means which, when the rich air-fuel ratio is judged to be greater than the rich target air-fuel ratio, sets a target air-fuel ratio to the rich air-fuel ratio; lean air-fuel ratio judgment means which judges, during the oxygen storage period, whether a lean air-fuel ratio obtained by adding the air-fuel ratio change amount to the current target air-fuel ratio is smaller than the lean target air-fuel ratio; and lean air-fuel ratio setup means which, when the lean air-fuel ratio is judged to be smaller than the lean target air-fuel ratio, sets the target air-fuel ratio to the lean air-fuel ratio.

According to a third aspect of the present invention, there is provided the catalyst deterioration detection device as described in the first aspect, further including element temperature detection means for detecting an element temperature of the oxygen sensor; wherein the oxygen storage amount detection condition setup means includes: rich target air-fuel ratio setup means for setting the rich target air-fuel ratio in accordance with the element temperature; and lean target air-fuel ratio setup means for setting the lean target air-fuel ratio in accordance with the element temperature.

According to a fourth aspect of the present invention, there is provided the catalyst deterioration detection device as described in the third aspect, wherein, when the element temperature is higher, the rich target air-fuel ratio setup means sets a rich target air-fuel ratio that increases the difference between a stoichiometric air-fuel ratio and the rich target air-fuel ratio; and wherein, when the element temperature is high, the lean target air-fuel ratio setup means sets a lean target air-fuel ratio that increases the difference between the stoichiometric air-fuel ratio and the lean target air-fuel ratio.

According to a fifth aspect of the present invention, there is provided the catalyst deterioration detection device as described in the first aspect, wherein the oxygen storage amount detection condition setup means includes element temperature control means which exercises control during the oxygen release period and the oxygen storage period so that the element temperature of the oxygen sensor agrees with a reference temperature higher than an activation temperature.

According to a sixth aspect of the present invention, there is provided the catalyst deterioration detection device as described in the fifth aspect, wherein the reference temperature is between 700° C. and 750° C.

According to a seventh aspect of the present invention, there is provided the catalyst deterioration detection device as described in any one of the first to sixth aspects, further including: integrated value computation means for computing an integrated value according to elapsed time since the beginning of the oxygen release period or an integrated value according to elapsed time since the beginning of the oxygen storage period; integrated value judgment means for judging whether the integrated value is smaller than a reference value; and air-fuel ratio switchover prohibition means which, when the integrated value is smaller than the reference value, prohibits an air-fuel ratio control from switching from the rich target air-fuel ratio to the lean target air-fuel ratio or switching from the lean target air-fuel ratio to the rich target air-fuel ratio.

According to an eighth aspect of the present invention, there is provided the catalyst deterioration detection device as described in the seventh aspect, further including intake air amount detection means for detecting the amount of intake air that is taken into the internal combustion engine; wherein the integrated value computation means sets the integrated value in accordance with the elapsed time and the intake air amount.

### ADVANTAGES OF THE INVENTION

The first aspect of the present invention detects the catalyst's maximum oxygen storage state and minimum oxygen storage state while exercising control to provide the rich or lean target air-fuel ratio for the internal combustion engine. Further, the first aspect of the present invention determines the oxygen storage amount, which is the amount of oxygen released or stored during the oxygen release period or oxygen storage period between the maximum oxygen storage state and minimum oxygen storage state, and judges the deterioration of the catalyst in accordance with the oxygen storage amount. The maximum or minimum oxygen storage state is detected in accordance with the output of the oxygen sensor installed downstream of the catalyst. Therefore, if the output of the oxygen sensor varies depending on a difference in the output detection conditions for the oxygen sensor, the detection of the maximum or minimum oxygen storage state varies, thereby varying the oxygen release period or oxygen storage period.

In this respect, the first aspect of the present invention sets up the oxygen storage amount detection conditions for correcting a variation that may occur in the oxygen release period or oxygen storage period depending on the difference in output detection conditions for the oxygen sensor. This makes it possible to eliminate the variation in the oxygen release period and oxygen storage period and accurately determine the oxygen storage amount. Therefore, the deterioration of the catalyst can be detected with increased accuracy.

Meanwhile, if, for instance, the exhaust gas flow rate or flow velocity is high in a situation where the intake air amount is large, the change per unit time in the concentration of each component in the exhaust gas becomes great. Therefore, when the intake air amount is large, the oxygen sensor responds to changes in the exhaust gas air-fuel ratio at increased sensitivity and changes its output with increased responsiveness. Therefore, when the exhaust gas air-fuel ratio prevailing downstream of the catalyst changes to a lean or rich air-fuel ratio, the response speed at which the oxygen sensor generates an output to indicate such a change is higher when the intake air amount is large than when the intake air amount is small. Therefore, when the intake air amount is large, the maximum or minimum oxygen storage state is detected earlier than when the intake air amount is small. As a result, the oxygen release period and oxygen storage period, which are periods between the maximum oxygen storage state and minimum oxygen storage state, are short when the intake air amount is large and long when the intake air amount is small.

In this respect, when control is exercised during the oxygen release period or oxygen storage period to provide a rich or lean target air-fuel ratio as the air-fuel ratio of the internal combustion engine, the second aspect of the present invention ensures that the amount of air-fuel ratio change from the current air-fuel ratio to the rich or lean target air-fuel ratio is based on the intake air amount. Further, when control is exercised to switch from a current target air-fuel ratio to the rich or lean target air-fuel ratio, the second aspect of the present invention gradually changes the target air-fuel ratio in accordance with the air-fuel ratio change amount before the target air-fuel ratio reaches the rich or lean target air-fuel ratio. Therefore, the period required for the air-fuel ratio to reach the target air-fuel ratio can be adjusted in accordance with the intake air amount. This makes it possible to reduce the variation in the oxygen release period or oxygen storage period, which is based on a variation in the intake air amount. As a result, the oxygen storage amount can be accurately detected.

Further, even when the exhaust gas concentration changes in the same manner, the diffusion speeds of exhaust gas components may differ from each other due to a variation in the element temperature of the oxygen sensor. As a result, the actual exhaust gas and the exhaust gas reaching an exhaust side electrode of the oxygen sensor may differ in the concentrations of their components. Therefore, the speed at which the oxygen sensor indicates a lean or rich output in response to the same exhaust gas concentration change varies with the element temperature of the oxygen sensor. Therefore, the timing with which the maximum or minimum oxygen storage state is detected varies with the element temperature of the oxygen sensor.

In this respect, when control is exercised during the oxygen release period or oxygen storage period to provide a rich or lean target air-fuel ratio as the air-fuel ratio, the third aspect of the present invention sets the rich or lean target air-fuel ratio in accordance with the element temperature. This ensures that when the exhaust gas air-fuel ratio prevailing downstream of the catalyst switches to a rich or lean air-fuel ratio, the rich or lean air-fuel ratio, that is, the concentration of a rich or lean component of the exhaust gas, is set in accordance with the element temperature. Therefore, in an environment where, for example, the exhaust gas concentration is greatly influenced by the diffusion speed difference based on the element temperature of the oxygen sensor, the concentration of each component of the exhaust gas can be increased to minimize the influence. This makes it possible to detect the maximum or minimum oxygen storage state with increased accuracy, thereby minimizing the variation in the length of the oxygen release period or oxygen storage period.

To be more precise, the diffusion speed generally increases when the element temperature is high. Therefore, the oxygen sensor acutely responds to exhaust gas concentration changes when the element temperature is high. As a result, when the element temperature is high, the oxygen sensor detects an exhaust gas air-fuel ratio change toward the lean or rich side earlier than usual, and generates an output accordingly. In other words, when the element temperature is high, the oxygen sensor generates an output indicative of leanness or richness before an exhaust gas concentration change toward the lean or rich side becomes significant. As a result, the maximum or minimum oxygen storage state is judged at a premature stage. It is therefore conceivable that the length of the oxygen release period or oxygen storage period may unduly decrease.

In this respect, when the element temperature is higher, the fourth aspect of the present invention selects a rich or lean target air-fuel ratio that is greatly different from the stoichiometric air-fuel ratio. In other words, when the catalyst reaches the maximum or minimum oxygen storage state, the degree of concentration change in the exhaust gas outflowing downstream of the catalyst increases with an increase in the element temperature. A high element temperature raises the diffusion speeds of exhaust gas components and increases the difference between such diffusion speeds. Therefore, an increase in the element temperature results in the detection of an increased degree of exhaust gas air-fuel ratio change toward the lean or rich side. Consequently, even if a great diffusion speed difference exists while the element temperature is high, the influence of the difference on the entire exhaust gas can be minimized. This makes it possible to accurately judge the maximum or minimum oxygen storage state and minimize the variation in the oxygen release period or oxygen storage period.

The fifth and sixth aspects of the present invention set the element temperature of the oxygen sensor to be a reference temperature higher than a normal activation temperature during the oxygen release period and oxygen storage period. This reduces the variation in the response time, which varies with the element temperature. As a result, it is possible to reduce the variation in the oxygen storage period and oxygen release period, which varies with the element temperature of the oxygen sensor.

Further, the responsiveness of the oxygen sensor varies with the degree of its deterioration. As the deterioration progresses, the oxygen sensor acutely responds to a slight change in the exhaust gas air-fuel ratio and generates a lean output or rich output. Therefore, when the deterioration of the oxygen sensor progresses, the maximum or minimum oxygen storage state is detected prematurely. As a result, the oxygen release period and oxygen storage period become shorter.

In this respect, the seventh and eighth aspects of the present invention determine an integrated value according to the elapsed time since the beginning of the oxygen release period or oxygen storage period. When the integrated value is smaller than the reference value, the seventh and eighth aspects of the present invention prohibit the target air-fuel ratio from switching to the rich or lean target air-fuel ratio without regard to the output from the oxygen sensor. This ensures that the current air-fuel ratio control state is maintained when the maximum/minimum oxygen storage state is detected prematurely due to oxygen sensor deterioration. Therefore, the oxygen storage amount is detected at the current air-fuel ratio until the maximum or minimum oxygen storage state is absolutely reached. This makes it possible to accurately detect the oxygen storage amount.

### BRIEF DESCRIPTION OF DRAWINGS

FIG. 1 is a schematic diagram illustrating a catalyst deterioration detection device according to a first embodiment of the present invention and the configuration of a system around it.

FIG. 2 illustrates the outputs of an air-fuel ratio sensor and an oxygen sensor that are generated while a catalyst deterioration detection process is performed in accordance with the first embodiment of the present invention.

FIG. 3 is a flowchart illustrating a control routine that an ECU executes to compute an oxygen storage integrated amount in accordance with the first embodiment of the present invention.

FIG. 4 is a graph illustrating the output characteristic of the oxygen sensor according to the first embodiment of the present invention.

FIG. 5 is a graph illustrating the relationship between a gas flow rate and the output response time of the oxygen sensor in accordance with the first embodiment of the present invention.

FIG. 6 is a diagram illustrating the relationship between an air-fuel ratio change amount provided by air-fuel ratio switchover during air-fuel ratio forced control and the gas flow rate in accordance with the first embodiment of the present invention.

FIG. 7 is a flowchart illustrating a control routine that the ECU executes to exercise air-fuel ratio forced control in accordance with the first embodiment of the present invention.

FIG. 8 is a graph illustrating the relationship between an element impedance and element temperature of the oxygen sensor.

FIG. 9 is a diagram illustrating the relationship between a target air-fuel ratio of air-fuel ratio forced control and the element impedance of the oxygen sensor in accordance with a second embodiment of the present invention.

FIG. 10 is a flowchart illustrating a control routine that the ECU executes to exercise air-fuel ratio forced control in accordance with the second embodiment of the present invention.

FIG. 11 is a flowchart illustrating a control routine that the ECU executes to compute the oxygen storage integrated amount in accordance with a third embodiment of the present invention.

FIG. 12 is a flowchart illustrating a control routine that the ECU executes to exercise air-fuel ratio forced control in accordance with the third embodiment of the present invention.

FIG. 13 is a graph illustrating the relationship between the duration of use and the output characteristic of the oxygen sensor.

FIG. 14 is a graph illustrating the relationship between the duration of use and the output response time of the oxygen sensor.

FIG. 15 is a diagram illustrating a predefined relationship between an intake air amount and a counter value in accordance with a fourth embodiment of the present invention.

FIG. 16 is a flowchart illustrating a control routine that the ECU executes to compute the oxygen storage integrated amount in accordance with the fourth embodiment of the present invention.

### DESCRIPTION OF NOTATIONS

10 internal combustion engine
12 intake path
14 exhaust path
16 air filter
18 intake temperature sensor
20 air flow mater
22 throttle valve
24 throttle sensor
28 fuel injection valve
30 upstream catalyst
32 downstream catalyst
34 air-fuel ration sensor
36 first oxygen sensor
38 second oxygen sensor
40 ECU

### BEST MODE FOR CARRYING OUT THE INVENTION

Embodiments of the present invention will now be described with reference to the accompanying drawings.

Like elements in the drawings are designated by the same reference numerals and will be described in an abbreviated manner or will not be redundantly described.

### First Embodiment

### [System Configuration of First Embodiment]

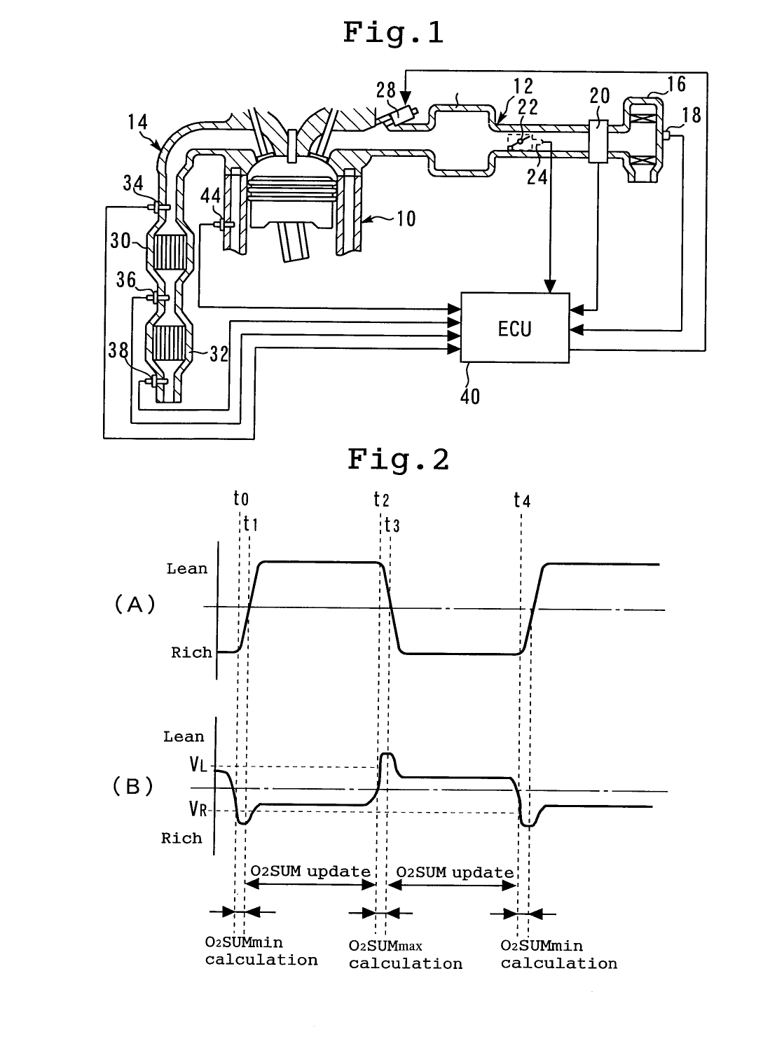

FIG. 1 is a schematic diagram illustrating the structure of an internal combustion engine 10 having a catalyst deterioration detection device according to a first embodiment of the present invention and the structures of its peripheral parts. Referring to FIG. 1, the internal combustion engine 10 communicates with an intake path 12 and an exhaust path 14. The intake path 12 has an air filter 16, which is positioned at an upstream end. The air filter 16 incorporates an intake temperature sensor 18, which detects intake air temperature (that is, ambient temperature). An air flow meter 20 is positioned downstream of the air filter 16. The air flow meter 20 is a sensor that detects the amount of intake air Ga that flows in the intake path. A throttle valve 22 is installed downstream of the air flow meter 20. A throttle sensor 24 is positioned near the throttle valve 22 to detect the opening of the throttle valve 22. A fuel injection valve 28 is positioned downstream of the throttle sensor 24 to inject fuel into an intake port of the internal combustion engine 10.

An upstream catalyst 30 (catalyst) and a downstream catalyst 32 are arranged in series within the exhaust path 14 of the internal combustion engine 10. These catalysts 30, 32 can store and release a certain amount of oxygen. If exhaust gas contains large amounts of HC, CO, and other unburned components, the catalysts 30, 32 use stored oxygen to oxidize them. If, on the other hand, the exhaust gas contains large amounts of NOx and other oxidized components, the catalysts 30, 32 reduce them and store released oxygen. The exhaust gas discharged from the internal combustion engine 10 is treated in the catalysts 30, 32 as described above for purification purposes.

The exhaust path 14 has an air-fuel ratio sensor 34, a first oxygen sensor 36 (oxygen sensor), and a second oxygen sensor 38. The air-fuel ratio sensor 34 is positioned upstream of the upstream catalyst 30. The first oxygen sensor 36 is positioned between the upstream catalyst 30 and downstream catalyst 32. The second oxygen sensor 38 is positioned downstream of the downstream catalyst 32. The air-fuel ratio sensor 34 generates an output according to the oxygen concentration in the exhaust gas. The first and second oxygen sensors 36, 38, on the other hand, significantly change their outputs when the oxygen concentration in the exhaust gas exceeds a predetermined value. The air-fuel ratio sensor 34 can detect the oxygen concentration in the exhaust gas flow to the upstream catalyst. This makes it possible to detect the air-fuel ratio A/F of an air-fuel mixture burned in the internal combustion engine 10. The first oxygen sensor 36 can judge whether the exhaust gas treated in the upstream catalyst 30 is fuel-rich (contains HC and CO) or fuel-lean (contains NOx). The second oxygen sensor 38 can judge whether the exhaust gas passing through the downstream catalyst 32 is fuel-rich (contains HC and CO) or fuel-lean (contains NOx).

The catalyst deterioration detection device according to the first embodiment includes an ECU (Electronic Control Unit) 40 as indicated in FIG. 1. The ECU 40 acquires information about the operating status of the internal combustion engine 10 because it is connected, for instance, to the intake temperature sensor 18, the air flow meter 20, the throttle sensor 24, the air-fuel ratio sensor 34, the first and second oxygen sensors 36, 38, and a water temperature sensor (not shown), which detects the temperature of cooling water for the internal combustion engine 10. The ECU 40 is also connected, for instance, to the fuel injection valve 28 and used to exercise necessary control in accordance with a control flow that is set up in compliance, for instance, with the acquired information.

[Catalyst Deterioration Detection Control by System according to First Embodiment]

In the system shown in FIG. 1, the exhaust gas discharged from the internal combustion engine 10 is first purified by the upstream catalyst 30. The downstream catalyst 32 performs a purification process on the exhaust gas that is not completely purified by the upstream catalyst 30. To constantly use a proper exhaust gas purification capability, therefore, it is particularly necessary to detect the deterioration of the upstream catalyst 30 without delay.

As described above, the upstream catalyst 30 purifies the exhaust gas by releasing oxygen into a rich exhaust gas containing HC, CO, and other unburned components and by storing excess oxygen in a lean exhaust gas containing NOx and the like. Therefore, the purification capability of the upstream catalyst 30 is determined by the oxygen storage capacity, that is, the maximum amount of oxygen that can be released or stored. In other words, the purification capability of the upstream catalyst 30 decreases with a decrease in the oxygen storage capacity. As such being the case, the catalyst deterioration detection device according to the first embodiment detects the oxygen storage capacity of the upstream catalyst 30 and judges in accordance with the detected value whether the upstream catalyst 30 is deteriorated.

First of all, an oxygen storage capacity detection method used by the catalyst deterioration detection device according to the first embodiment will be described. FIG. 2 is timing diagram illustrating a case where the ECU 40 exercises control for oxygen storage capacity detection. In FIG. 2, (A) shows changes that occur in the air-fuel ratio sensor 34 during oxygen storage capacity detection. On the other hand, in FIG. 2, (B) shows changes that occur in the first oxygen sensor 36 during oxygen storage capacity detection. Forced control is exercised during oxygen storage capacity detection so that the air-fuel ratio of the air-fuel mixture supplied to the internal combustion engine 10 is either rich or lean. Control exercised during oxygen storage capacity detection to regulate the air-fuel ratio of the air-fuel mixture is hereinafter referred to as “air-fuel ratio forced control.”

FIG. 2 illustrates a case where the air-fuel ratio is controlled with a rich target air-fuel ratio selected for the internal combustion engine 10 before time t0. While control is exercised to maintain a rich air-fuel ratio, the exhaust gas supplied to the upstream catalyst 30 contains HC, CO, and other unburned components and lacks oxygen. When such an exhaust gas is supplied, the upstream catalyst 30 releases stored oxygen and oxidizes HC and CO for exhaust gas purification purposes. If such a state continues for an extended period of time, the upstream catalyst 30 releases the entire oxygen and enters a minimum oxygen storage state in which HC and CO can no longer be oxidized.

When the upstream catalyst 30 reaches the minimum oxygen storage state, the exhaust gas is no longer purified in the upstream catalyst 30. Therefore, the exhaust gas that contains HC and CO and lacks oxygen begins to outflow downstream of the upstream catalyst 30. As a result, the first oxygen sensor 36 outputs a value that is smaller than a richness judgment value VR and indicative of a rich exhaust gas (this output value is hereinafter referred to as a “rich output”). Consequently, observing the output from the first oxygen sensor 36 makes it possible to detect the timing with which the exhaust gas lacking oxygen flows downstream of the upstream catalyst 30, that is, the timing with which the upstream catalyst 30 reaches the minimum oxygen storage state. This timing corresponds to time t0 in FIG. 2.

When the minimum oxygen storage state is detected as the first oxygen sensor 36 generates a rich output as described above, the internal combustion engine 10 forcibly switches to a lean target air-fuel ratio. When control is exercised to provide a lean air-fuel ratio, the value output from the air-fuel ratio sensor 34 subsequently becomes biased toward the lean side. The waveform shown in FIG. 2(A) represents a state where the output generated from the air-fuel ratio sensor 34 is inverted to a value biased toward the lean side at time t1. While the output from the air-fuel ratio sensor 34 is biased toward the lean side, that is, while the exhaust gas containing excess oxygen flows to the upstream catalyst 30, the upstream catalyst 30 stores the excess oxygen in the exhaust gas and reduces NOx to purify the exhaust gas. If this state continues for an extended period of time, the oxygen is stored to the full oxygen storage capacity so that no more NOx can be reduced. In other words, a maximum oxygen storage state arises.

In the maximum oxygen storage state, the exhaust gas containing excess oxygen including NOx begins to outflow downstream of the upstream catalyst 30, thereby causing the first oxygen sensor 36 to output a value that is greater than a leanness judgment value VL and indicative of a lean exhaust gas (this output value is hereinafter referred to as a “lean output”). Consequently, observing the output from the first oxygen sensor 36 makes it possible to detect the timing with which the exhaust gas containing excess oxygen flows downstream of the upstream catalyst 30, that is, the timing with which the upstream catalyst 30 reaches the maximum oxygen storage state. This timing corresponds to time t2 in FIG. 2.

When the maximum oxygen storage state is detected as the first oxygen sensor 36 generates a lean output, the internal combustion engine 10 forcibly switches to a rich target air-fuel ratio again. When control is exercised to provide a rich air-fuel ratio, the value output from the air-fuel ratio sensor 34 subsequently becomes biased toward the rich side. The waveform shown in FIG. 2(A) represents a state where the output generated from the air-fuel ratio sensor 34 is inverted to a value biased toward the rich side at time t3. While the output from the air-fuel ratio sensor 34 is biased toward the rich side, that is, while the exhaust gas lacking oxygen flows to the upstream catalyst, the upstream catalyst 30 releases oxygen into the exhaust gas and oxidizes HC and CO to purify the exhaust gas. If this state persists, the upstream catalyst 30 releases the entire oxygen again and enters the minimum oxygen storage state. In this state, the first oxygen sensor 36 generates a rich output again.

When the first oxygen sensor 36 generates a rich output, the catalyst deterioration detection device repeats the above-described process that has been performed since t0. As a result, the minimum oxygen storage state where the entire oxygen is released from the upstream catalyst 30 and the maximum oxygen storage state where oxygen is stored to the full oxygen storage capacity repeatedly arise.

As described above, the catalyst deterioration detection device detects the minimum oxygen storage state and maximum oxygen storage state, and exercises control to provide a rich or lean air-fuel ratio for the air-fuel mixture so that the minimum and maximum oxygen storage states repeatedly arise. In the meantime, the amount of oxygen stored or released by the upstream catalyst 30 per unit time can be determined in accordance with the air-fuel ratio A/F of an exhaust gas inflow to the upstream catalyst 30 and the intake air amount Ga. It is now assumed that the amount of oxygen stored is a positive oxygen amount and that the amount of oxygen released is a negative oxygen amount. Both of these oxygen amounts are hereinafter referred to as the oxygen storage amount.

The catalyst deterioration detection device determines the oxygen storage capacity of the upstream catalyst 30 by determining the oxygen storage amount during an oxygen storage period during which the status changes from the minimum oxygen storage state to the maximum oxygen storage state and determining the oxygen storage amount during an oxygen release period during which the status changes from the maximum oxygen storage state to the minimum oxygen storage state. Consequently, whether the catalyst is normal or deteriorated is judged by determining whether the oxygen storage capacity is greater than a predetermined judgment value.

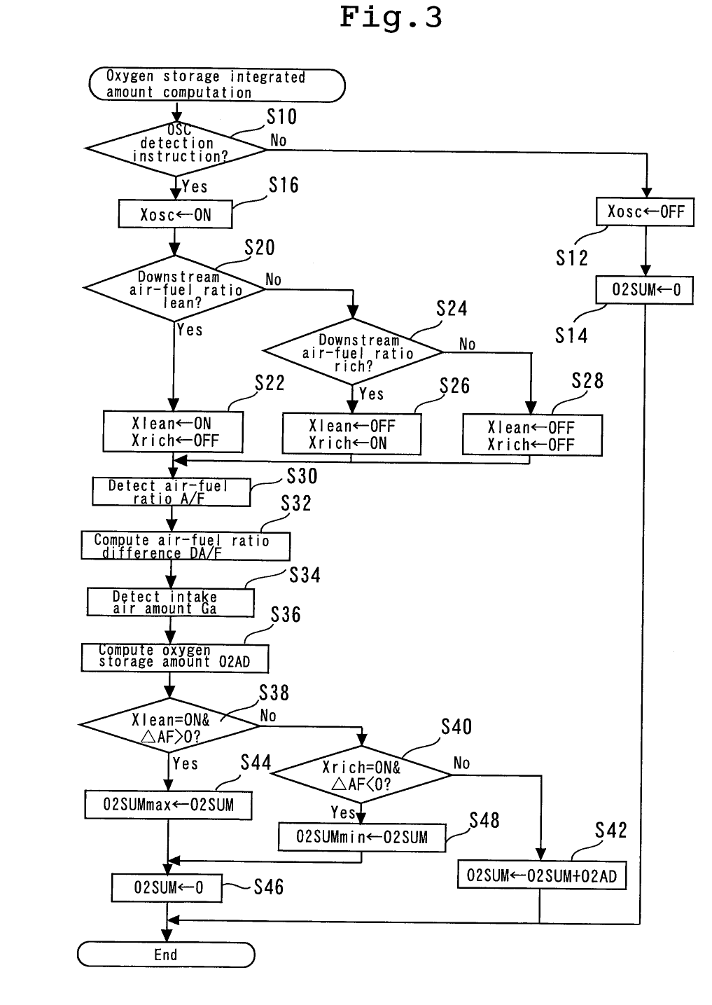

FIG. 3 is a flowchart illustrating an oxygen storage integrated amount computation routine that the ECU 40 executes as a preliminary process for determining the oxygen storage capacity. The routine shown in FIG. 3 is a timed interrupt routine that is repeatedly executed at predetermined time intervals.

The routine shown in FIG. 3 first performs step S10 to judge whether an instruction for detecting the oxygen storage capacity OSC is issued. If the instruction for detecting the oxygen storage capacity OSC is not recognized in step S10, step S12 is performed to turn OFF an oxygen storage capacity detection flag Xosc. The oxygen storage capacity detection flag Xosc remains ON while air-fuel ratio forced control is exercised to detect the oxygen storage capacity after the recognition of the instruction for detecting the oxygen storage capacity OSC. Next, step S14 is performed to clear an oxygen storage integrated amount O2SUM (O2SUM=0), which is a later-described integrated value of the oxygen storage amount. The current process then terminates.

If, on the other hand, the instruction for detecting the oxygen storage capacity OSC is recognized in step S10, step S16 is performed to turn ON the oxygen storage capacity detection flag Xosc. While the oxygen storage capacity detection flag Xosc is ON, a later-described air-fuel ratio forced control routine is executed in parallel with the execution of the routine shown in FIG. 3.

Next, the routine shown in FIG. 3 performs step S20 to judge whether the air-fuel ratio of the exhaust gas outflowing downstream of the upstream catalyst 30 is lean, or more specifically, whether a lean output (>VL) is generated by the first oxygen sensor 36. It should be noted that the first oxygen sensor 36 generates a lean output only when the upstream catalyst 30 is in the maximum oxygen storage state.

If the judgment result obtained in step S20 indicates that the air-fuel ratio of the exhaust gas outflowing downstream of the upstream catalyst 30 is lean, step S22 is performed to turn ON a lean flag Xlean and turn OFF a rich flag Xrich. The lean flag Xlean remains ON while a lean output is generated by the first oxygen sensor 36. The rich flag Xrich remains ON while the first oxygen sensor 36 generates a rich output during a later-described process.

If, on the other hand, the judgment result obtained in step S20 does not indicate that the air-fuel ratio of the exhaust gas outflowing downstream of the upstream catalyst 30 is lean, step S24 is performed to judge whether the air-fuel ratio of the exhaust gas outflowing downstream of the upstream catalyst 30 is rich, or more specifically, whether a rich output (<VR) is generated by the first oxygen sensor 36. It should be noted that the first oxygen sensor 36 generates a rich output only when the upstream catalyst 30 is in the minimum oxygen storage state.

If the judgment result obtained in step S24 indicates that the air-fuel ratio of the exhaust gas outflowing downstream of the upstream catalyst 30 is rich, step S26 is performed to turn ON the rich flag Xrich and turn OFF the lean flag Xlean.

If, on the other hand, the judgment result obtained in step S24 does not indicate that the air-fuel ratio of the exhaust gas outflowing downstream of the upstream catalyst 30 is rich, it can be concluded that the exhaust gas is normally purified by the upstream catalyst 30, that is, the upstream catalyst 30 is neither in the maximum oxygen storage state nor in the minimum oxygen storage state. In this instance, step S28 is performed to turn OFF both the lean flag Xlean and rich flag Xrich.

The routine shown in FIG. 3 performs step S30 to detect the air-fuel ratio A/F after a process is performed in step S22, S26, or S28 to turn ON or OFF the flags Xlean, Xrich. The air-fuel ratio A/F is detected in accordance with the output from the air-fuel ratio sensor 34. It means that the air-fuel ratio A/F detected here is the air-fuel ratio of the exhaust gas flowing into the upstream catalyst 30.

Next, step S32 is performed to compute an air-fuel ratio difference ΔA/F. The air-fuel ratio difference ΔA/F is the difference between a stoichiometric air-fuel ratio A/Fst and the air-fuel ratio A/F detected in step S30, that is, the air-fuel ratio A/F of the exhaust gas flowing into the upstream catalyst 30, and computed in accordance with Equation (1) below.

ΔA/F=A/F−A/Fst (1)

Next, step S34 is performed to detect the intake air amount Ga in accordance with the output from the air flow meter 20. Step S36 is then performed to determine the oxygen storage amount O2AD, which is the amount of oxygen released or stored by the upstream catalyst 30 per unit time, in accordance with the air-fuel ratio difference ΔA/F and intake air amount Ga. The oxygen storage amount O2AD is computed in accordance with a map or arithmetic expression stored in the ECU 40. The oxygen storage amount O2AD takes a positive value when the air-fuel ratio A/F of the exhaust gas flowing into the upstream catalyst 30 is lean or a negative value when it is rich.

Next, step S38 is performed to judge whether conditions where the lean flag Xlean is ON while the air-fuel ratio difference ΔA/F is greater than zero are established. The lean flag Xlean turns ON when the first oxygen sensor 36 generates a lean output in step S22. Therefore, the conditions for step S38 are established when the exhaust gas flowing into the upstream catalyst 30 and the exhaust gas outflowing downstream of the upstream catalyst 30 are both lean. In other words, the conditions are established when the oxygen storage amount no longer changes with the upstream catalyst 30 placed in the maximum oxygen storage state during an interval, for instance, between time t2 and time t3 in FIG. 2.

If the judgment result obtained in step S38 does not indicate that the conditions are established, step S40 is performed to judge whether conditions where the rich flag Xrich is ON while the air-fuel ratio difference ΔA/F is smaller than zero are established. The rich flag Xrich turns ON when the first oxygen sensor 36 generates a rich output in step S26. In other words, step S26 is performed to judge whether the exhaust gas is rich on both the upstream and downstream sides of the upstream catalyst 30. This condition is established when the oxygen storage amount no longer changes with the upstream catalyst 30 placed in the minimum oxygen storage state during an interval, for instance, between time t0 and time t1 in FIG. 2.

Therefore, if the judgment result obtained in step S40 does not indicate that the condition is established, it can be concluded that the amount of oxygen stored by the upstream catalyst 30 is changed while oxygen is currently stored or released by the upstream catalyst 30. It means that the present time is within an interval, for instance, between time t1 and time t2 or between time t3 and time t4 in FIG. 2. In this instance, step S42 is performed to update the oxygen storage integrated amount O2SUM by adding the oxygen storage amount O2AD computed during the current processing cycle to the oxygen storage integrated amount O2SUM computed during the previous processing cycle. The current process then terminates.

If, on the other hand, the judgment result obtained in step S38 indicates that the conditions are established, it can be concluded that the oxygen storage amount no longer changes with the upstream catalyst 30 placed in the maximum oxygen storage state. Therefore, step S44 is performed to store the oxygen storage integrated amount O2SUM, which is the current integrated value of the oxygen storage amount, as the maximum oxygen storage integrated amount O2SUMmax without updating it. Subsequently, step S46 is performed to clear the oxygen storage integrated amount O2SUM (O2SUM=0). The current process then terminates.

If the judgment result obtained in step S44 indicates that the condition is established, it is concluded that the oxygen storage amount does not change as the upstream catalyst 30 has reached the minimum oxygen storage state and can release no more oxygen. Therefore, step S48 is performed to store the current oxygen storage integrated amount O2SUM as the minimum oxygen storage integrated amount O2SUMmin without updating it. Subsequently, step S42 is performed to clear the oxygen storage integrated amount O2SUM (O2SUM=0). The current process then terminates.

The routine shown in FIG. 3 can compute the maximum oxygen storage integrated amount O2SUMmax, which is the oxygen storage integrated amount in the maximum oxygen storage state, and the minimum oxygen storage integrated amount O2SUMmin, which is the oxygen storage integrated amount in the minimum oxygen storage state, by increasing or decreasing the oxygen storage integrated amount O2SUM in accordance with an increase/decrease in the amount of oxygen stored by the upstream catalyst 30. When these values are determined, the ECU 40 can compute the oxygen storage capacity OSC by subtracting the minimum oxygen storage integrated amount O2SUMmin from the maximum oxygen storage integrated amount O2SUMmax. The catalyst deterioration detection device checks whether the computed oxygen storage capacity OSC is greater than a predetermined judgment value and then judges according to the result of the check whether the upstream catalyst 30 is normal or deteriorated. The judgment value is set in accordance, for instance, with the properties of the upstream catalyst 30 and the required purification power, and stored in advance in the ECU 40.

[Characteristic Control by System according to First Embodiment]

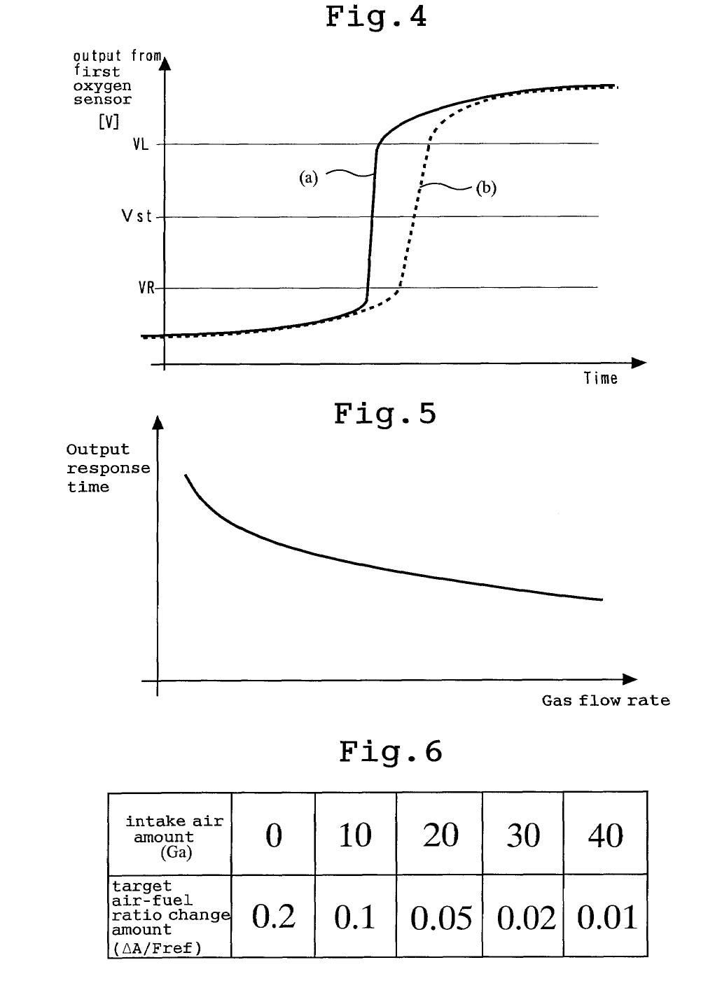

FIG. 4 is a graph illustrating an output characteristic of the first oxygen sensor 36. This graph schematically shows how the output from the first oxygen sensor 36 changes when the exhaust gas air-fuel ratio to be detected by the first oxygen sensor 36 changes from rich to lean. In FIG. 4, the horizontal axis represents time, whereas the vertical axis represents the output generated from the first oxygen sensor 36. A solid line (a) and a dotted line (b) in FIG. 4 indicate the output results about an exhaust gas exhibiting the same concentration changes. The solid line (a) shows a case where the exhaust gas flow rate is high, whereas the dotted line (b) shows a case where the exhaust gas flow rate is low.

When the air-fuel ratio of the exhaust gas changes from rich to lean, the first oxygen sensor 36 drastically increases its output as shown in FIG. 4 and generates a lean output (>VL) to indicate that the air-fuel ratio is lean. In this instance, the change rate of a drastic change section in the output from the first oxygen sensor 36 greatly varies with the exhaust gas flow rate. More specifically, when the exhaust gas flow rate is high, the first oxygen sensor 36 drastically changes its output and rapidly switches from a rich output (<VR) to a lean output as indicated by the solid line (a) in FIG. 4. When, on the other hand, the exhaust gas flow rate is low, the first oxygen sensor 36 gradually changes its output. More specifically, the first oxygen sensor 36 begins to change its output later than when the gas flow rate is high, and switches from a rich output to a lean output over a long period of time.

The reason is that the amount of gas concentration change per unit time increases with an increase in the gas flow rate. In other words, an increase in the gas flow rate increases the concentration change per unit time in the exhaust gas supplied to the first oxygen sensor 36. Therefore, the concentration change is transmitted at an increased speed to an exhaust side electrode, which is an electrode positioned on the exhaust gas side of the first oxygen sensor 36. When, on the other hand, the exhaust gas flow rate is low, the concentration change in the exhaust gas is transmitted to the exhaust side electrode as a relatively gradual change. Consequently, even when the exhaust gas undergoes the same concentration change, the responsiveness of the first oxygen sensor 36 varies with the exhaust gas flow rate as indicated by the solid line (a) and dotted line (b) in FIG. 4. The higher the exhaust gas flow rate, the shorter the response time required to invoke an output change in accordance with the concentration change. The same also holds true when the air-fuel ratio of the exhaust gas conversely changes from lean to rich. More specifically, the first oxygen sensor 36 switches from a lean output to a rich output rapidly at a high exhaust gas flow rate and slowly at a low exhaust gas flow rate.

FIG. 5 is a graph illustrating the relationship between the exhaust gas flow rate prevailing in the exhaust path near the installed first oxygen sensor 36 and the output response time of the first oxygen sensor 36. The horizontal axis represents the gas flow rate, whereas the vertical axis represents the output response time. FIG. 5 indicates that the output response time of the first oxygen sensor 36 for a change in the exhaust gas concentration decreases with an increase in the exhaust gas flow rate and increases with a decrease in the exhaust gas flow rate.

The exhaust gas discharged from the upstream catalyst 30 is either lean or rich when the upstream catalyst 30 is in the maximum or minimum oxygen storage state. To detect whether the maximum or minimum oxygen storage state is reached, therefore, the catalyst deterioration detection device checks whether the first oxygen sensor 36 generates a lean output (>VL) or a rich output (<VR).

However, the timing with which the first oxygen sensor 36 generates a lean or rich output in accordance with the exhaust gas concentration varies with the exhaust gas flow rate as described above. More specifically, when a lean or rich exhaust gas is supplied to the first oxygen sensor 36 with the upstream catalyst 30 placed in the maximum or minimum oxygen storage state, the response time required for the first oxygen sensor 36 to generate a lean output (>VL) or a rich output (<VR) decreases with an increase in the exhaust gas flow rate. In other words, when the exhaust gas flow rate is high, the maximum oxygen storage state is recognized with a lean output generated while the exhaust gas air-fuel ratio is richer than when the exhaust gas flow rate is low, and the minimum oxygen storage state is recognized with a rich output generated while the exhaust gas air-fuel ratio is leaner than when the exhaust gas flow rate is low. As a result, when the exhaust gas flow rate is high, the time interval between the instant at which the air-fuel ratio of the exhaust gas flow to the upstream catalyst 30 becomes rich and the instant at which the minimum oxygen storage state is detected (oxygen release period, that is, for example, the interval between time t3 and time t4 in FIG. 2) or the time interval between the instant at which the air-fuel ratio becomes lean and the instant at which the maximum oxygen storage state is detected (oxygen storage period, that is, for example, the interval between time t1 and time t2 in FIG. 2) varies with a variation in the exhaust gas flow rate.

Particularly, the exhaust gas that exists downstream of the upstream catalyst 30 and flows into the first oxygen sensor 36 is a thin gas that is purified when it passes through the upstream catalyst 30. Therefore, even if a slight concentration variation occurs per unit time due to a variation in the exhaust gas flow rate, such a concentration variation may significantly affect the exhaust gas existing downstream of the upstream catalyst 30, thereby exerting a great influence upon the output of the first oxygen sensor 36. More specifically, the timing with which the first oxygen sensor 36 generates a lean or rich output may greatly vary. As a result, the oxygen release period or oxygen storage period may significantly vary depending on whether the exhaust gas flow is high or low.

As described in conjunction with the routine shown in FIG. 3, the oxygen storage integrated amount is obtained by adding up the oxygen storage amounts that are successively detected during the oxygen release period or oxygen storage period. Therefore, if a significant variation occurs in the oxygen release period or oxygen storage period, it is practically impossible to successively compute the oxygen storage amounts with proper timing and add them up. This makes it difficult to accurately compute the oxygen storage integrated amount.

As such being the case, the catalyst deterioration detection device according to the first embodiment exercises control as described below in order to offset the variation in the oxygen storage amount integration time (that is, the oxygen release period or oxygen storage period), which arises depending on the exhaust gas flow rate, and provide sufficient integration time at an appropriate point of time to permit the computation of the oxygen storage integrated amount even when the exhaust gas flow rate is high. When air-fuel ratio forced control is exercised to switch the target air-fuel ratio from a rich side target air-fuel ratio (rich target air-fuel ratio A/Frich) to a lean side target air-fuel ratio (lean target air-fuel ratio A/Flean) or from the lean target air-fuel ratio A/Flean to the rich target air-fuel ratio A/Frich, the catalyst deterioration detection device according to the first embodiment varies the target air-fuel ratio in units of an air-fuel ratio change amount AA/Fref until the rich or lean target air-fuel ratio A/Frich, A/Flean is reached.

In the above instance, the air-fuel ratio change amount ΔA/Fref is set in accordance with the exhaust gas flow rate. The exhaust gas flow rate correlates with the intake air amount Ga so that the exhaust gas flow rate increases with an increase in the intake air amount Ga. Therefore, the first embodiment determines the air-fuel ratio change amount ΔA/Fref for air-fuel ratio switchover in accordance with the intake air amount Ga.

FIG. 6 shows a map that defines the relationship between the intake air amount Ga and the target air-fuel ratio change amount ΔA/Fref. As indicated in the map in FIG. 6, the setting for the target air-fuel ratio change amount ΔA/Fref for air-fuel ratio switchover during air-fuel ratio forced control decreases with an increase in the intake air amount Ga. Consequently, when air-fuel ratio switchover is effected in a situation where the intake air amount Ga is large, that is, the exhaust gas flow rate is high, the air-fuel ratio gradually changes in units of a small air-fuel ratio change amount ΔA/Fref.

As described above, the higher the exhaust gas flow rate, that is, the larger the intake air amount Ga, the larger the exhaust gas concentration change amount per unit time. On the other hand, the catalyst deterioration detection device according to the first embodiment reduces the air-fuel ratio change amount ΔA/Fref to perform setup so that the concentration change in the exhaust gas flow to the upstream catalyst 30 decreases with an increase in the intake air amount Ga. When air-fuel ratio switchover is effected, therefore, the variation in the exhaust gas concentration change amount per unit time, which occurs due to a variation in the intake air amount Ga, can be offset before the rich target air-fuel ratio A/Frich or lean target air-fuel ratio A/Flean is reached. Consequently, the air-fuel ratio of the exhaust gas reaching the exhaust side electrode of the first oxygen sensor 36 remains substantially unchanged during at least an air-fuel ratio switchover period no matter whether the intake air amount Ga varies. This makes it possible to more or less reduce the variation in the timing with which a lean output and rich output are generated.

Further, when the intake air amount Ga is large, control is exercised to gradually vary the target air-fuel ratio. Therefore, it is possible to increase the oxygen storage period and oxygen release period, that is, to obtain increased oxygen storage amount integration time. Since this increases the sensitivity of the first oxygen sensor 36, it is possible to avoid an undue decrease in the integration time. Consequently, sufficient oxygen storage amount integration time can be obtained to accurately determine the oxygen storage amount even when the intake air amount Gas varies.

[Characteristic Control Routine Executed by Device according to First Embodiment]

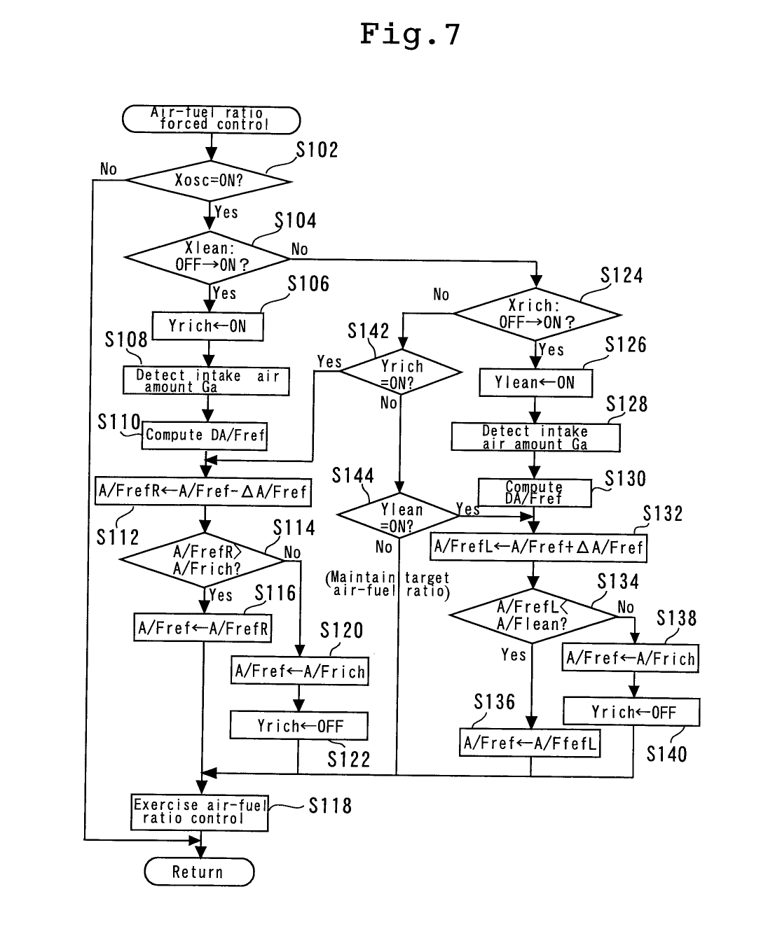

FIG. 7 is a flowchart illustrating a control routine that is executed by the ECU 40 of the catalyst deterioration detection device according to the first embodiment. The routine shown in FIG. 7 is a timed interrupt routine that is repeatedly executed at predetermined time intervals to provide air-fuel ratio control during the execution of air-fuel ratio forced control.

This routine first performs step S102 to judge whether the oxygen storage capacity detection flag Xosc is ON. The oxygen storage capacity detection flag Xosc is ON only when steps S12 and S16 in FIG. 3 are performed to compute the oxygen storage integrated amount in response to an instruction for detecting the oxygen storage capacity OSC. If the judgment result obtained in step S102 indicates that the oxygen storage capacity detection flag Xosc is OFF, the current process terminates without doing anything.

If, on the other hand, the judgment result obtained in step S102 indicates that the oxygen storage capacity detection flag Xosc is ON, step S104 is performed to judge whether the status of the lean flag Xlean is changed from OFF to ON. The lean flag Xlean remains ON while a lean output is generated by the first oxygen sensor 36 (refer to steps S20 to S22 in FIG. 3). Therefore, the condition prescribed in step S108 is established only when the output from the first oxygen sensor 36 changes from a value smaller than the leanness judgment value VL to a value greater than the leanness judgment value VL during the previous and current processing cycles.

If it is found that the status of the lean flag Xlean is changed from OFF to ON, step S106 is performed to turn ON a rich switchover flag Yrich. The rich switchover flag Yrich remains ON during the time interval between the instant at which a lean output from the first oxygen sensor 36 is recognized, that is, the upstream catalyst 30 is found to have reached the maximum oxygen storage state, and the instant at which air-fuel ratio switchover to a rich target air-fuel ratio A/Frich is completed.

Next, step S108 is performed to detect the current intake air amount Ga. The intake air amount Ga can be detected in accordance with an output generated from the air flow meter 20. Step S110 is then performed to compute the air-fuel ratio change amount ΔA/Fref. The air-fuel ratio change amount ΔA/Fref is computed from the predefined map shown in FIG. 6 in accordance with the intake air amount Ga detected in step S108. As described earlier, the setting for the air-fuel ratio change amount ΔA/Fref decreases with an increase in the intake air amount Ga. In other words, when the intake air amount Ga increases, the amount of change in the target air-fuel ratio A/Fref for subsequent air-fuel ratio switchover becomes gradual.

Next, step S112 is performed to compute a rich air-fuel ratio A/FrefR. While the rich switchover flag Yrich is ON, that is, while the air-fuel ratio is changing to the rich side, the rich air-fuel ratio A/FrefR, which serves as the target air-fuel ratio, is determined by subtracting the change amount ΔA/Fref from the currently set target air-fuel ratio A/Fref in accordance with Equation (2) below.

Rich air-fuel ratio A/FrefR=current target air-fuel ratio A/Fref−air-fuel ratio change amount ΔA/Fref (2)

Next, step S114 is performed to judge whether the computed rich air-fuel ratio A/FrefR is greater than the rich target air-fuel ratio A/Frich. When the obtained judgment result indicates that A/FrefR>A/Frich, the rich air-fuel ratio A/FrefR, which serves as the target air-fuel ratio A/Fref, does not reach the rich target air-fuel ratio A/Frich at the current air-fuel ratio setting. Therefore, step S116 is performed so that the target air-fuel ratio A/Fref is the target air-fuel ratio A/FrefR computed in step S112. Subsequently, step S118 is performed to exercise air-fuel ratio control in accordance with the set target air-fuel ratio A/Fref. The current process then terminates.

If, on the other hand, the judgment result obtained in step S114 does not indicate that A/FrefR>A/Frich, that is, if the target air-fuel ratio A/FrefR for air-fuel ratio switchover to the rich side is not greater than the rich target air-fuel ratio A/Frich, step S120 is performed to set the rich target air-fuel ratio A/Frich as the target air-fuel ratio A/Fref. Next, step S122 is performed to turn OFF the rich switchover flag Yrich. Subsequently, step S118 is performed to exercise air-fuel ratio control in accordance with the target air-fuel ratio A/Fref set in step S120. The current process then terminates.

Subsequently, the routine shown in FIG. 7 is repeatedly executed. After completion of steps S120 and S122, however, the upstream catalyst 30 is in the minimum oxygen storage state. Therefore, the rich target air-fuel ratio A/Frich is maintained as the target air-fuel ratio A/Fref until the status of the rich flag Xrich changes from OFF to ON in step S104.

The same process is performed even after the first oxygen sensor 36 generates a rich output. More specifically, if the judgment result obtained in step S104 does not indicate that the status of the lean flag Xlean is changed from OFF to ON, step S124 is performed to judge whether the status of the rich flag Xrich is changed from OFF to ON. The rich flag Xrich remains ON while a rich output is generated from the first oxygen sensor 36 (refer to steps S24 to S26 in FIG. 3). Therefore, the condition prescribed in step S124 is established only when the output from the first oxygen sensor 36 changes from a value not smaller than the richness judgment value VR to a value smaller than the richness judgment value VR during the previous and current processing cycles.

If it is found that the status of the rich flag Xrich is changed from OFF to ON, step S126 is performed to turn ON a lean switchover flag Ylean. The lean switchover flag Ylean turns ON when it is detected that the upstream catalyst 30 has reached the minimum oxygen storage state. Subsequently, the lean switchover flag Ylean remains ON until the target air-fuel ratio A/Fref completely switches to the lean target air-fuel ratio A/Flean.

Next, step S128 is performed to detect the current intake air amount Ga. Step S130 is then performed to compute the change amount ΔA/Fref for the target air-fuel ratio in accordance with the detected intake air amount Ga. Next, step S132 is performed to compute a lean air-fuel ratio A/FrefL, which serves as the target air-fuel ratio for air-fuel ratio switchover to the lean side. The lean air-fuel ratio A/FrefL is determined by adding the air-fuel ratio change amount ΔA/Fref to the currently set target air-fuel ratio A/Fref in accordance with Equation (3) below.

Lean air-fuel ratio A/FrefL=current target air-fuel ratio A/Fref+air-fuel ratio change amount ΔA/Fref (3)

Next, step S134 is performed to judge whether the lean air-fuel ratio A/FrefL is smaller than the lean target air-fuel ratio A/Flean. If the obtained judgment result indicates that A/FrefL<A/Flean, it is concluded that the lean air-fuel ratio A/FrefL has not reached the lean target air-fuel ratio A/Flean in the current process either. Therefore, step S136 is performed to set the computed lean air-fuel ratio A/FrefL as the target air-fuel ratio A/Fref.

If, on the other hand, the judgment result obtained in step S134 does not indicate that the lean air-fuel ratio A/FrefL is smaller than the lean target air-fuel ratio A/Flean, that is, if the lean air-fuel ratio A/FrefL is found to be not smaller than the lean target air-fuel ratio A/Flean, step S138 is performed to set the lean target air-fuel ratio A/Flean as the target air-fuel ratio A/Fref. Subsequently, step S140 is performed to turn OFF the lean switchover flag Ylean.

When the target air-fuel ratio A/Fref is set in step S136 or S138, step S118 is performed to control the air-fuel ratio so that the set air-fuel ratio prevails. The current process then terminates.

Subsequently, the routine shown in FIG. 7 is repeatedly executed. After completion of steps S138 and S140, however, the upstream catalyst 30 is back in the maximum oxygen storage state. Therefore, the lean target air-fuel ratio A/Flean is maintained as the target air-fuel ratio A/Fref until the status of the lean flag Xlean changes from OFF to ON in step S104.

If, on the other hand, the judgment result obtained in step S124 does not indicate that the status of the rich flag is changed from OFF to ON, that is, if neither of the lean flags Xlean, Xrich has changed its status from OFF to ON, step S142 is performed to judge whether the rich switchover flag Yrich is ON. The rich switchover flag Yrich remains ON while the target air-fuel ratio is changing from lean to rich during air-fuel ratio forced control.

Therefore, if it is found that the rich switchover flag is ON, the routine proceeds to step S112 and computes the rich air-fuel ratio A/FrefR in accordance with Equation (2) above. If it is found that the rich air-fuel ratio A/FrefR>rich target air-fuel ratio A/Frich, step S116 is performed to set the rich air-fuel ratio A/FrefR as the target air-fuel ratio A/Frich. This process is performed during a repeated execution of the routine until the judgment result obtained in step S114 indicates that the rich air-fuel ratio A/FrefR is not greater than the rich target air-fuel ratio A/Frich. In other words, when the air-fuel ratio switches from lean to rich, control is exercised to decrease the target air-fuel ratio in units of the change amount ΔA/Fref, which is determined in accordance with the intake air amount Ga, until the rich target air-fuel ratio A/Frich is reached. When it is subsequently found that the rich air-fuel ratio A/FrefR is not greater than the rich target air-fuel ratio A/Frich, step S120 is performed to set the rich target air-fuel ratio A/Frich as the target air-fuel ratio A/Fref. Next, step S122 is performed to turn OFF the rich switchover flag Yrich. Step S118 is then performed to control the air-fuel ratio.

If the judgment result obtained in step S142 indicates that the rich switchover flag Yrich is OFF, step S144 is performed to judge whether the lean switchover flag Ylean is ON. The lean switchover flag Ylean remains ON while the target air-fuel ratio is changing from rich to lean during air-fuel ratio forced control.

If the judgment result obtained in step S144 indicates that the lean switchover flag is ON, the routine proceeds to step S132 and computes the lean air-fuel ratio A/FrefL. If it is found in step S134 that the lean air-fuel ratio A/FrefL<lean target air-fuel ratio A/Flean, step S136 is performed to set the lean air-fuel ratio A/FrefL as the target air-fuel ratio A/Fref. Step S118 is then performed to control the air-fuel ratio. This process for switching to a lean side air-fuel ratio is performed until the judgment result obtained in step S134 indicates that the lean air-fuel ratio A/FrefL is not smaller than the lean target air-fuel ratio A/Flean. In other words, when the air-fuel ratio switches to a lean side, control is exercised to increase the target air-fuel ratio in units of the air-fuel ratio change amount AA/Fref, which is determined in accordance with the intake air amount Ga, until the target air-fuel ratio A/Fref reaches the lean target air-fuel ratio A/Flean. When it is subsequently found that the lean air-fuel ratio A/FrefL is not smaller than the lean target air-fuel ratio A/Flean, step S138 is performed to set the lean target air-fuel ratio A/Flean as the target air-fuel ratio A/Fref. Next, step S140 is performed to turn OFF the lean switchover flag Ylean. Step S118 is then performed to control the air-fuel ratio.

If, on the other hand, the judgment result obtained in step S144 does not indicate that the lean switchover flag Ylean is ON, step S118 is performed to maintain the currently set target air-fuel ratio and control the air-fuel ratio.

When detecting the oxygen storage capacity for catalyst deterioration detection purposes, the catalyst deterioration detection device according to the first embodiment exercises air-fuel ratio forced control to forcibly switch to a rich or lean air-fuel ratio as described above. Further, when switching the air-fuel ratio from rich to lean or from lean to rich, the catalyst deterioration detection device according to the first embodiment uses the air-fuel ratio change amount ΔA/Fref based on the intake air amount Ga. More specifically, the air-fuel ratio change amount ΔA/Fref is set to be large when the intake air amount Ga is small. When the intake air amount Ga is large, on the other hand, the air-fuel ratio change amount ΔA/Fref is set to be small. As a result, when the exhaust gas reaching the exhaust side electrode of the first oxygen sensor 36 undergoes a great concentration change in a situation where the intake air amount Ga is large, the change in the exhaust gas air-fuel ratio is gradual. Therefore, the concentration change in the exhaust gas reaching the first oxygen sensor 36 can be confined within a certain range by offsetting the variation in the concentration change per unit time, which varies with the intake air amount Ga.

Further, even when the first oxygen sensor 36 acutely responds to an air-fuel ratio change and quickly generates a lean or rich output in a situation where the intake air amount Ga is large, the period of time required to reach the maximum or minimum oxygen storage state can be increased by providing a gradual air-fuel ratio change to the lean or rich side. Therefore, even when the intake air amount Ga is large, the oxygen storage amount integration time for oxygen storage capacity detection can be kept long. Consequently, the catalyst deterioration detection device according to the first embodiment can accurately compute the oxygen storage capacity and judge the deterioration of a catalyst with increased accuracy.

It is assumed that the first embodiment determines the air-fuel ratio change amount ΔA/Fref in accordance with the intake air amount Ga when switching to a rich or lean air-fuel ratio during air-fuel ratio forced control. However, the present invention does not necessarily use the intake air amount Ga as a parameter for determining the air-fuel ratio change amount ΔA/Fref. For example, the air-fuel ratio change amount ΔA/Fref may be determined in accordance with the direct measurement of an intake gas flow rate. The concentration change per unit time of the exhaust gas discharged downstream of the upstream catalyst 30 increases not only when the intake gas flow rate is high but also when the intake gas flow velocity is high. Therefore, the output response speed of the first oxygen sensor 36 also varies with gas flow velocity. Consequently, exercising similar control to reduce the air-fuel ratio change amount ΔA/Fref when the intake gas flow velocity is high makes it possible to reduce the variation in the integration time that varies with the output response time of the first oxygen sensor 36.

Further, the present invention does not necessarily use a value according to the map shown in FIG. 6 as the air-fuel ratio change amount ΔA/Fref for the intake air amount Ga. The air-fuel ratio change amount AA/Fref varies, for instance, with the properties of the upstream catalyst 30. Therefore, it can be defined as appropriate for the internal combustion engine 10 in which the catalyst deterioration detection device is to be mounted.

In the first embodiment, for example, performing step S20 implements the “maximum oxygen storage state detection means” according to the present invention, performing step S24 implements the “minimum oxygen storage state detection means” according to the present invention, performing steps S116 to S120 implements the “rich air-fuel ratio control means,” performing steps S134 to S140 and S118 implements the “lean air-fuel ratio control means,” performing steps S36 to S48 implements the “oxygen storage amount detection means,” and performing steps S110 to S116 and steps S130 to S136 implements the “oxygen storage amount detection condition setup means.”

Further, in the first embodiment, for example, performing steps S108 and S128 implements the “intake air amount detection means” according to the present invention, performing steps S110 and S130 implements the “change amount computation means,” performing step S114 implements the “rich air-fuel ratio judgment means,” performing step S116 implements the “rich air-fuel ratio setup means,” performing step S134 implements the “lean air-fuel ratio judgment means,” and performing step S136 implements the “lean air-fuel ratio setup means.”

### Second Embodiment

The catalyst deterioration detection device according to a second embodiment of the present invention and a system around it have the same configuration as described in conjunction with the first embodiment (see FIG. 1). In the second embodiment, too, the ECU 40, which serves as the catalyst deterioration detection device, detects the deterioration of the upstream catalyst 30 by detecting the oxygen storage capacity of the upstream catalyst 30. More specifically, the second embodiment exercises air-fuel ratio forced control in the same manner as the first embodiment, detects the oxygen storage capacity of the catalyst during the execution of such control, and judges the deterioration of the catalyst in accordance with the oxygen storage capacity.

More specifically, the catalyst deterioration detection device according to the second embodiment exercises the same control as the catalyst deterioration detection device according to the first embodiment except that the former does not exercise control to vary the air-fuel ratio in units of a preselected air-fuel change amount until a rich or lean target air-fuel ratio is reached when air-fuel ratio switchover is to be effected during air-fuel ratio forced control, and that the former sets an appropriate air-fuel ratio in accordance with the element temperature of the first oxygen sensor 36 as a lean or rich target air-fuel ratio for an air-fuel ratio forced control period and instantly switches to a lean or rich air-fuel ratio at the time of air-fuel ratio changeover.

While air-fuel ratio forced control is exercised, the temperature of the exhaust gas discharged from the upstream catalyst 30 depends, for instance, on the operating conditions for the internal combustion engine 10 and varies with the situation. When the exhaust gas temperature varies as described above, the proportions of rich components in the exhaust gas and the proportions of lean components in the exhaust gas both vary no matter whether the air-fuel ratio of the exhaust gas remains unchanged.

More specifically, when the exhaust gas temperature rises, the proportion of CH₄, which is a rich HC component of the exhaust gas, tends to increase. CH₄ has a higher diffusion speed than the other HC components. It means that CH₄ passes, for instance, through a diffusion layer formed on the surface of the exhaust side electrode and reaches an exhaust side electrode catalyst earlier than the other HC components. Further, when the exhaust gas temperature rises, the temperature of the sensor element of the first oxygen sensor 36 (element temperature) also rises under the influence of the high-temperature exhaust gas. When the element temperature of the first oxygen sensor 36 rises, the temperature, for instance, of the diffusion layer of the exhaust side electrode surface of the first oxygen sensor 36 also rises. A rise in the temperature of the diffusion layer impairs the function for governing the flow rate of the exhaust gas directed into the sensor. When such a function is impaired, especially, a rich H component has a higher diffusion speed than the other components.

If the exhaust gas temperature is high when the exhaust gas air-fuel ratio changes from lean to rich, the CH₄ and H components having a high diffusion speed exert a strong influence as described above. Therefore, the first oxygen sensor 36 promptly responds to such an air-fuel ratio change and generates a rich output while the exhaust gas existing downstream of the upstream catalyst 30 has a relatively lean air-fuel ratio. If, on the contrary, the exhaust gas temperature is low, the first oxygen sensor 36 gradually changes its output. When the exhaust gas reaches a relatively rich air-fuel ratio, the first oxygen sensor 36 responds to such an air-fuel ratio change and generates an output indicative of richness.

More specifically, when the upstream catalyst 30 reaches the minimum oxygen storage state, allowing a rich exhaust gas to begin flowing into the first oxygen sensor 36, the first oxygen sensor 36 generates a rich output indicative of the reached state with relative promptness while the actual air-fuel ratio of the exhaust gas is lean. The higher the exhaust gas temperature, the more promptly the first oxygen sensor 36 generates such a rich output. As described above, the rich side response speed of the first oxygen sensor 36 increases with an increase in the exhaust gas temperature. An increase in such a response speed advances the timing with which the first oxygen sensor 36 detects the minimum oxygen storage state.

Meanwhile, an increase in the exhaust gas temperature increases the proportion of NO₂ in NOx, which is a lean component of the exhaust gas, whereas a decrease in the exhaust gas temperature increases the proportion of NO in NOx. NO₂ contains a larger amount of oxygen in its molecule than NO. In the exhaust side electrode catalyst, therefore, NO₂ releases a larger amount of oxygen. Consequently, if the exhaust gas changes to have a lean air-fuel ratio, the first oxygen sensor 36 generates an output indicative of leanness at a relatively rich air-fuel ratio when a high-temperature exhaust gas having a great proportion of NO₂ flows inward.

More specifically, when the upstream catalyst 30 reaches the maximum oxygen storage state, allowing a lean exhaust gas to begin outflowing downstream of the upstream catalyst 30, the first oxygen sensor 30 generates a lean output indicative of the reached state with relative promptness and at a relatively rich air-fuel ratio while the temperature of the exhaust gas is high. If, on the contrary, the temperature is low, the response time required for the generation of a lean output (>VL) increases because of an increase in the proportion of NO in a lean component of the exhaust gas.

In particular, the exhaust gas existing downstream of the upstream catalyst 30 is purified in the upstream catalyst 30. Therefore, its concentration change is slight even when the upstream catalyst 30 reaches the maximum or minimum oxygen storage state to enlean or enrich the exhaust gas air-fuel ratio. Therefore, if the proportions of rich or lean components of the exhaust gas and the diffusion speeds of the components passing through the diffusion layer vary due to the variation in the exhaust gas temperature as described above, thereby causing the exhaust gas concentration change to vary, the concentration change exerts a great overall influence upon a thin exhaust gas no matter whether the variation is slight.

As described above, a high exhaust gas temperature decreases the response time that is required for actually generating a rich or lean output in response to a change to a rich or lean air-fuel ratio in the exhaust gas discharged downstream of the upstream catalyst 30. In other words, a high exhaust gas temperature advances and varies the timing with which the maximum or minimum oxygen storage state is detected. This may cause a variation that excessively shortens the oxygen storage period or oxygen release period. As a result, oxygen storage amounts cannot be added up during an appropriate period. Thus, the resulting oxygen storage integrated amount differs from an actual value. To accurately compute the oxygen storage capacity and judge the deterioration of the upstream catalyst with high precision, however, it is preferred that the oxygen storage integrated amount be more accurate. It is therefore desired that a variation in the integration time be avoided to provide fixed integration time.

Under the above circumstances, the second embodiment assures that a lean or rich side target air-fuel ratio for the first oxygen sensor 36 during air-fuel ratio forced control is based on the element temperature of the first oxygen sensor. More specifically, when the exhaust gas temperature is high, the second embodiment performs setup so that the lean target air-fuel ratio A/Flean or rich target air-fuel ratio A/Frich greatly differs from the stoichiometric air-fuel ratio A/F.

When setup is performed as described above so that the rich or lean target air-fuel ratio greatly differs from the stoichiometric air-fuel ratio, the air-fuel ratio of the exhaust gas flowing into the upstream catalyst 30 is significantly lean or rich. Therefore, when the upstream catalyst 30 reaches the maximum or minimum oxygen storage state, the rich or lean exhaust gas that begins to discharge downstream of the upstream catalyst 30 has a great air-fuel ratio. Thus, when the exhaust gas temperature is high, the first oxygen sensor 36 detects such a significant air-fuel ratio change in the exhaust gas. Consequently, even when the exhaust gas temperature is high, it is possible to reduce the influence of changes in the proportions of components of the exhaust gas, which arise out of an exhaust gas temperature rise, and of variations in the diffusion speeds of the components upon the output of the first oxygen sensor 36. Therefore, when the exhaust gas temperature is high, it is possible to avoid an undue increase in the output response speed of the first oxygen sensor 36 and the detection of the maximum or minimum oxygen storage state at a rich or lean air-fuel ratio.

Meanwhile, the element temperature inevitably increases with an increase in the exhaust gas temperature. It is therefore assumed that the aforementioned lean target air-fuel ratio A/Flean or rich target air-fuel ratio A/Frich is to be determined in accordance with the element temperature. This makes it possible to perform target air-fuel ratio setup in consideration of exhaust gas temperature changes as well.

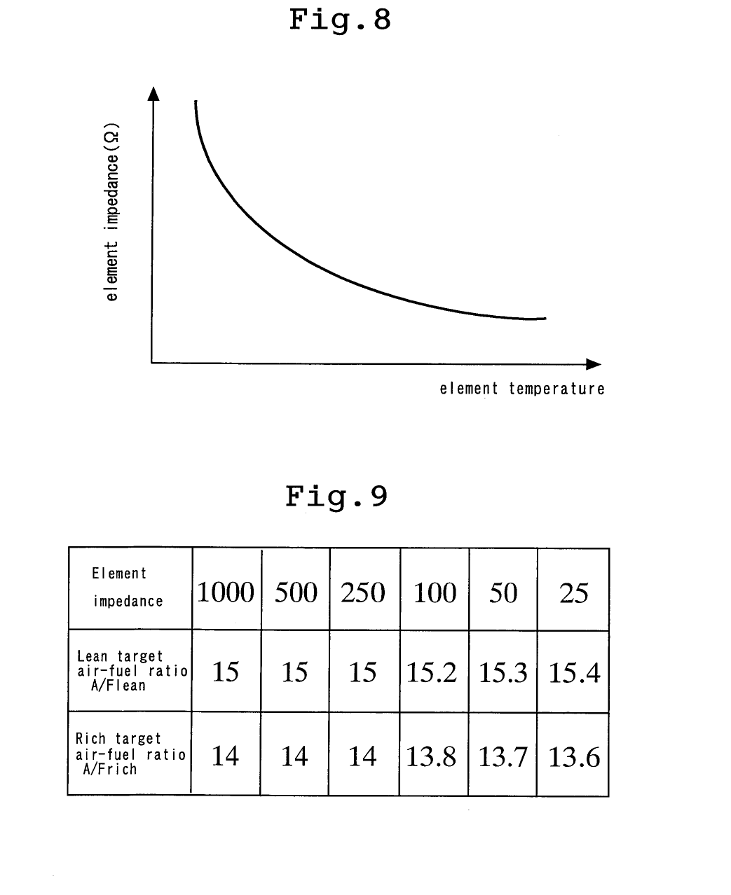

Further, the element temperature correlates with the impedance of the sensor element. FIG. 8 is a graph illustrating the relationship between the element temperature and element impedance. As indicated in FIG. 8, the element temperature increases with a decrease in the element impedance. This relationship can be used to determine the element temperature from a detected element impedance. Therefore, the lean target air-fuel ratio A/Flean or rich target air-fuel ratio A/Frich, which uses the element temperature as a parameter, can be set as a value based on the element impedance.

FIG. 9 shows a map illustrating the relationship between the element impedance, lean target air-fuel ratio A/Flean, and rich target air-fuel ratio A/Frich. In accordance with the relationship indicated by the map in FIG. 9, the target air-fuel ratios A/Flean, A/Frich are set so that the difference from the stoichiometric air-fuel ratio A/Fst increases with a decrease in the element impedance (that is, with an increase in the element temperature).

In accordance with the relationship indicated in FIG. 9, the ECU 40 stores the map that illustrates the relationship between the element impedance, lean target air-fuel ratio A/Flean, and rich target air-fuel ratio A/Frich. Air-fuel ratio forced control for detecting the deterioration of the upstream catalyst 30 is exercised so as to detect the element impedance of the first oxygen sensor 36, set the lean target air-fuel ratio A/Flean or rich target air-fuel ratio A/Frich in accordance with the detected value, and control the air-fuel ratio in accordance with the set target air-fuel ratio.

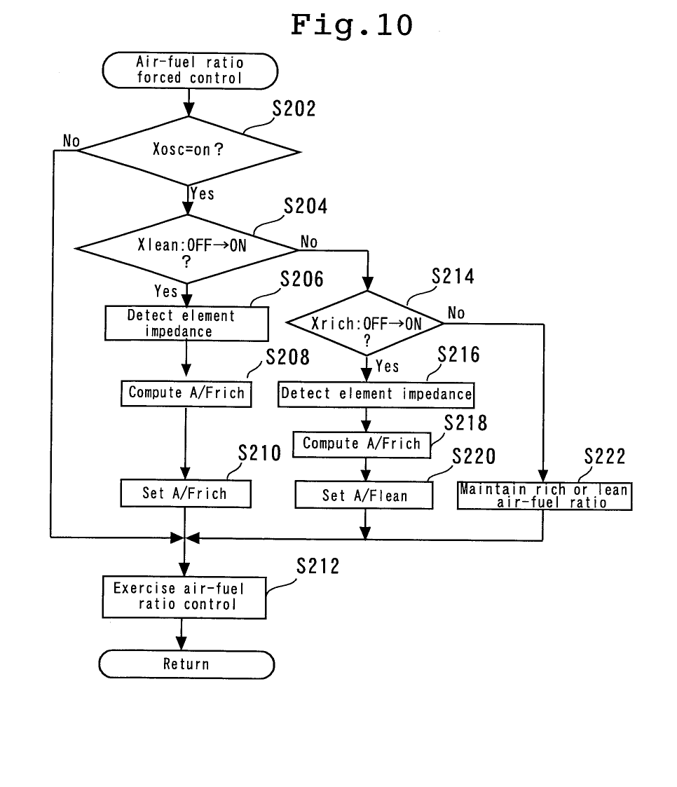

FIG. 10 is a flowchart illustrating a control routine that the ECU 40 executes in accordance with the second embodiment of the present invention. The routine shown in FIG. 10 is an air-fuel ratio forced control routine for oxygen storage integrated amount computation and executed instead of the routine shown in FIG. 7 while the lean flag Xlean and rich flag Xrich are controlled as indicated in FIG. 3.

More specifically, the routine shown in FIG. 10 performs step S202 to judge whether the oxygen storage capacity detection flag Xosc is ON. When the judgment result obtained in step S202 indicates that the oxygen storage capacity detection flag Xosc is ON, step S204 is performed to judge whether the status of the lean flag Xlean is changed from OFF to ON. The lean flag Xlean remains ON while the maximum oxygen storage state is detected in steps S20 to S22 in FIG. 3. Therefore, the condition prescribed in step S204 is established only when the output from the first oxygen sensor 36 changes from a value smaller than a predetermined judgment value to a value not smaller than the lean output during the previous and current processes.

When the condition prescribed in step S204 is established, step S206 is performed to detect the element impedance. The element impedance is detected by applying an element impedance detection voltage to the sensor element and detecting a change in the current flowing in the sensor element. Next, step S208 is performed to compute the rich target air-fuel ratio A/Frich in accordance with the element impedance. The rich target air-fuel ratio A/Frich is set to a value based on the element impedance in accordance with the map (see FIG. 9) that is stored in advance in the ECU 40. The computed rich target air-fuel ratio A/Frich increases with an increase in the element impedance (that is, with a decrease in the element temperature). Subsequently, step S210 is performed to set the air-fuel ratio to the rich target air-fuel ratio A/Frich obtained in step S208. Control is then exercised in step S212 so that the air-fuel ratio agrees with the set rich target air-fuel ratio A/Frich.

If, on the other hand, the judgment result obtained in step S204 does not indicate that the status of the lean flag Xlean is changed from OFF to ON, step S214 is performed to judge whether the status of the rich flag Xrich is changed from OFF to ON. The rich flag Xrich remains ON while the minimum oxygen storage state is detected (steps S24 and S26 in FIG. 3). Therefore, the condition prescribed in step S214 is established only when the output from the first oxygen sensor 36 changes from a value not smaller than a predetermined judgment value to a rich output value smaller than the judgment value during the previous and current processes.

If the judgment result obtained in step S214 indicates that the status of the rich flag Xrich is changed from OFF to ON, step S216 is performed to detect the element impedance. Subsequently, step S218 is performed to compute the lean target air-fuel ratio A/Flean in accordance with the element impedance. In accordance with the map that is stored in advance in the ECU 40, the lean target air-fuel ratio A/Flean is set to a value according to the element impedance. The setting for the lean target air-fuel ratio A/Flean increases with an increase in the element impedance (that is, with a decrease in the element temperature). Subsequently, step S220 is performed to set the target air-fuel ratio to the lean target air-fuel ratio A/Flean obtained in step S218. Step S212 is then performed to exercise control so that the air-fuel ratio agrees with the set lean target air-fuel ratio A/Flean.

If neither of the conditions prescribed in steps S204 and S214 is established, it is concluded that neither the maximum oxygen storage state nor the minimum oxygen storage state is reached. Therefore, step S222 is performed so that the target air-fuel ratio is maintained at the currently set air-fuel ratio. Step S212 is then performed to control the air-fuel ratio.

As described above, the second embodiment of the present invention performs setup for air-fuel ratio forced control exercised upon oxygen storage capacity detection so that the difference between the lean target air-fuel ratio A/Flean or rich target air-fuel ratio A/Frich and the stoichiometric air-fuel ratio A/Fst increases with an increase in the element temperature of the first oxygen sensor 36. As a result, when the element temperature is high, that is, when the exhaust gas temperature is expected to be high, the air-fuel ratio of the exhaust gas flowing into the upstream catalyst 30 can be greatly enleaned or enriched. In this instance, the rich or lean exhaust gas, which begins to discharge downstream of the upstream catalyst 30 when the upstream catalyst 30 reaches the maximum or minimum oxygen storage state, has a great air-fuel ratio. Therefore, when the exhaust gas temperature is high, the first oxygen sensor 36 detects a change in the exhaust gas air-fuel ratio that greatly changes as mentioned above. Consequently, even when the exhaust gas temperature is high, it is possible to reduce the influence of changes in the proportions of components of the exhaust gas, which occur due to an exhaust gas temperature rise, and of variations in the diffusion speeds of the components upon the output of the first oxygen sensor 36. Thus, when the exhaust gas temperature is high, it is possible to avoid an undue increase in the output response speed of the first oxygen sensor 36 and the detection of the maximum or minimum oxygen storage state at a rich or lean air-fuel ratio.

The second embodiment has been described on the assumption that the element impedance is detected and used as a parameter to set the target air-fuel ratios A/Flean, A/Frich. However, the present invention does not necessarily use such a parameter to set the target air-fuel ratios A/Flean, A/Frich. The present invention may alternatively use a parameter that represents the exhaust gas temperature. More specifically, the present invention may directly detect the element temperature or the temperature of an exhaust gas inflow to the first oxygen sensor 36 and use the detected value as a parameter for setting the target air-fuel ratios A/Flean, A/Frich.

Further, it is assumed that the second embodiment defines the lean or rich target air-fuel ratio A/Flean, A/Frich in accordance with the element impedance and immediately changes the air-fuel ratio to the defined lean or rich target air-fuel ratio A/Flean, A/Frich at the time of air-fuel ratio switchover. However, the present invention does not necessarily invoke such an immediate air-fuel ratio change. For example, when the air-fuel ratio is to be changed, the present invention may use the defined lean or rich target air-fuel ratio A/Flean, A/Frich as the final target air-fuel ratio and vary the air-fuel ratio in units of the air-fuel ratio change amount AA/Fref, as is the case with the first embodiment, until the air-fuel ratio reaches the final target air-fuel ratio.

In the second embodiment, for example, performing steps S206 or S216 implements the “element temperature detection means,” performing step S208 implements the “rich target air-fuel ratio setup means,” performing steps S210 and S212 implements the “rich air-fuel ratio control means,” performing step S218 implements the “lean target air-fuel ratio setup means,” and performing steps S220 and S212 implements the “lean air-fuel ratio control means.”

### Third Embodiment

The catalyst deterioration detection device according to a third embodiment of the present invention and a system including the catalyst deterioration detection device have the same configuration as described in conjunction with the first embodiment (see FIG. 1). The catalyst deterioration detection device according to the third embodiment exercises air-fuel ratio forced control to switch to a rich or lean air-fuel ratio as is the case with the catalyst deterioration detection device according to the first or second embodiment, determines the oxygen storage capacity OSC by detecting the oxygen storage integrated amount O2SUMmax, O2SUMmin in the maximum or minimum oxygen storage state, and judges the deterioration of the upstream catalyst 30 in accordance with the oxygen storage capacity OSC. The catalyst deterioration detection device according to the third embodiment exercises the same control as the device according to the second embodiment except that the former uses a predetermined fixed value as the lean or rich target air-fuel ratio A/Flean, A/Frich for air-fuel ratio forced control and maintains the sensor element at a predetermined high temperature while the oxygen storage capacity is detected under air-fuel ratio forced control.

When the element temperature of the first oxygen sensor 36 is low, the temperature of the diffusion layer of the exhaust side electrode is also low. When the diffusion layer temperature is low as described above, the diffusion speeds of exhaust gas components in the diffusion layer are higher than when the diffusion layer temperature is high. Therefore, even when the air-fuel ratio of the exhaust gas surrounding the first oxygen sensor 36 remains unchanged, the air-fuel ratio of the exhaust gas that passes through the diffusion layer and reaches the exhaust side electrode may vary depending on whether the element temperature (that is, the diffusion layer temperature) is high or low.

As described above, the first oxygen sensor 36 detects an exhaust gas that has passed through the upstream catalyst 30 and reduced the concentration of its rich or lean components. Therefore, even when the variations in the diffusion speeds of the components, which are based on an element temperature variation, are slight as described above, it is likely that the output from the first oxygen sensor 36 will be greatly affected. In other words, the output responsiveness of the first oxygen sensor 36 varies with the element temperature. If the output responsiveness of the first oxygen sensor 36 varies with the element temperature, the timing with which the first oxygen sensor 36 generates a lean or rich output greatly varies. As a result, the oxygen storage period and oxygen release period varies with the element temperature. This also varies the oxygen storage integrated amount, which is integrated during such periods. To formulate a catalyst deterioration judgment with high accuracy, however, it is preferred that the variation in the oxygen storage integrated amount, which arises out of a variation in the element temperature, be reduced to accurately determine the oxygen storage capacity.

Under the above circumstances, the catalyst deterioration detection device according to the third embodiment ensures that the sensor element is heated to a predetermined temperature higher than the activation temperature (to a temperature between approximately 700° C. and 750° C. in the third embodiment) while the oxygen storage integrated amount is computed under air-fuel ratio forced control. When control is exercised as described above to obtain a high sensor element temperature, it is possible to keep the sensor element temperature fixed no matter whether the exhaust gas temperature is high or low. As a result, the output from the first oxygen sensor 36 can be acquired while the diffusion layer temperature is constantly maintained within a certain range. This makes it possible to suppress the variation in the diffusion speeds of the components of the exhaust gas and constantly generate a lean or rich output in response to a change in the exhaust gas air-fuel ratio at a virtually fixed response speed. Consequently, the variation in the oxygen storage period or oxygen release period can be reduced to accurately calculate the oxygen storage integrated amount.

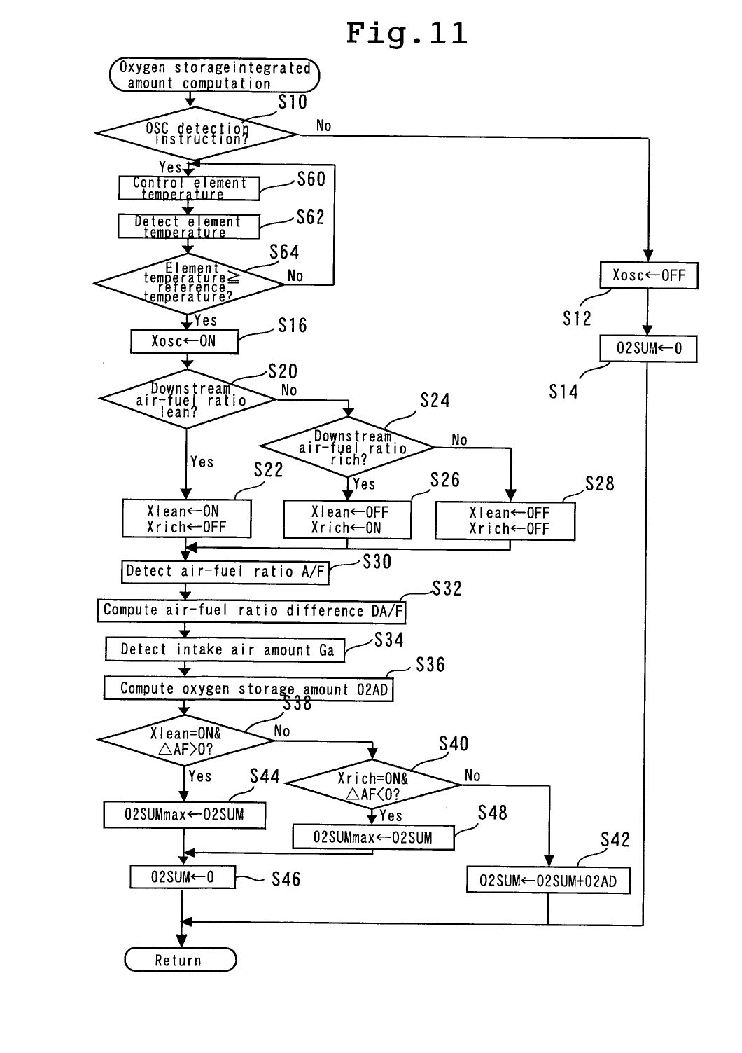

FIG. 11 illustrates a control routine that the system executes in accordance with the third embodiment of the present invention. The routine shown in FIG. 11 is a routine that the ECU 40 executes instead of the routine shown in FIG. 3, which describes the first embodiment. The routine shown in FIG. 11 is the same as the routine shown in FIG. 3 except that the former performs steps S60 to S64 during an interval between steps S10 and S16 in the routine shown in FIG. 3.

More specifically, if the judgment result obtained in step S10 indicates that the oxygen storage capacity detection flag Xosc is ON, the routine shown in FIG. 11 first performs step S60 to set a reference temperature predefined for oxygen storage capacity detection (e.g., a temperature between approximately 700° C. and 750° C.) as a control target value for the element temperature of the first oxygen sensor 36 and exercise element temperature control accordingly. More specifically, control is exercised to regulate the power supplied to a heater installed near the sensor element and heat the sensor element to its target temperature.

Next, step S62 is performed to detect the element temperature of the first oxygen sensor 36. The element temperature can be determined, for instance, from a detected element impedance of the first oxygen sensor 36 (see FIG. 8). Step S64 is then performed to judge whether the current element temperature of the first oxygen sensor 36 is not lower than the reference temperature for oxygen storage capacity detection. If the judgment result obtained in step S64 indicates that the element temperature of the first oxygen sensor 36 is lower than the reference temperature, the routine returns to step S60 and performs steps S60 to S62 again to exercise temperature rise control over the sensor element and detect the element temperature. The steps S60 and S62 are repeatedly performed until the element temperature 2 reference temperature in step S64.

If, as a result of a repeated execution of steps S60 and S62, the judgment result obtained in step S64 indicates that the element temperature of the first oxygen sensor 36 is not lower than the reference temperature, the routine concludes that the reference temperature for oxygen storage capacity detection is reached. Step S16 is then performed to turn ON the oxygen storage capacity detection flag Xosc. Subsequently, the routine performs steps S22 to S46 in the same manner as indicated in FIG. 3 to exercise ON/OFF control over the lean flag Xlean and rich flag Xrich and compute the oxygen storage integrated amount under air-fuel ratio forced control as is the case with the first embodiment.

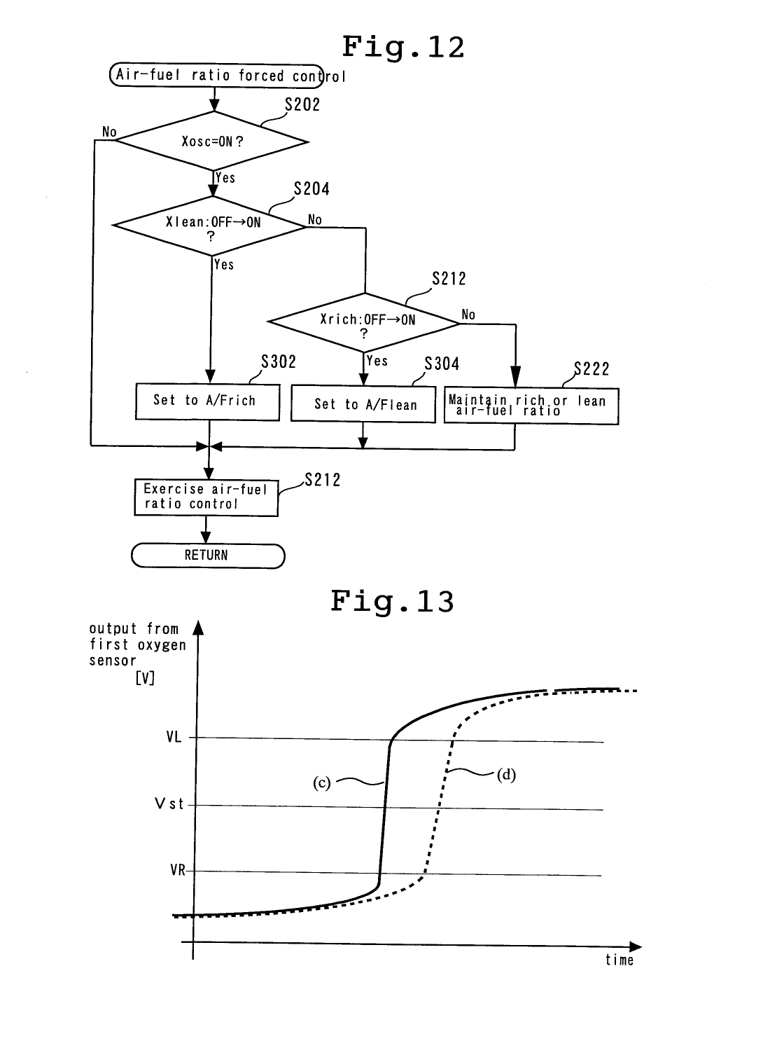

FIG. 12 shows an air-fuel ratio forced control routine for oxygen storage integrated amount computation that the ECU 40 executes in accordance with the third embodiment of the present invention. The routine shown in FIG. 12 is executed instead of the routine shown in FIG. 10 while ON/OFF control is exercised over the lean flag Xlean and rich flag Xrich as indicated in FIG. 11. The routine shown in FIG. 12 is the same as the routine shown in FIG. 10 except that the former does not perform steps S206 to S208 and steps S216 to S218 and performs steps S302 and S304 instead of steps S210 and S220.

More specifically, if the judgment result obtained in step S202 indicates that the oxygen storage capacity detection flag Xosc is ON, and the judgment result obtained in step S204 indicates that the status of the lean flag Xlean is changed from OFF to ON, the routine shown in FIG. 12 performs step S302 to set the air-fuel ratio to the rich target air-fuel ratio A/Frich. The rich target air-fuel ratio A/Frich is a predetermined fixed value stored in the ECU 40. In other words, the rich target air-fuel ratio A/Frich is a fixed value, which does not vary with the element temperature or other factors. In the third embodiment, the overall response speed of the first oxygen sensor increases in order to maintain a high element temperature. In consideration of such a response speed increase, the rich target air-fuel ratio A/Frich may be set, for instance, to a value slightly smaller than a target air-fuel ratio for a conventional device, that is, to a value that increases the difference from the stoichiometric air-fuel ratio. After the rich target air-fuel ratio is set, step S212 is performed to control the air-fuel ratio in accordance with the rich target air-fuel ratio A/Frich. The current process then terminates.

If, on the other hand, the judgment result obtained in step S214 indicates that the status of the rich flag Xrich is changed from OFF to ON, step S304 is performed to set the air-fuel ratio to the lean target air-fuel ratio A/Flean. Like the rich target air-fuel ratio A/Frich, the lean target air-fuel ratio A/Flean is a predetermined fixed value stored in the ECU 40. Further, since control is exercised here to maintain a high element temperature, the overall response speed of the first oxygen sensor increases. In consideration of such a response speed increase, the lean target air-fuel ratio A/Flean may be set, for instance, to a value greater than a target air-fuel ratio for a conventional device, that is, to a value that increases the difference from the stoichiometric air-fuel ratio. After the lean target air-fuel ratio A/Flean is set, step S212 is performed to control the air-fuel ratio in accordance with the set lean target air-fuel ratio A/Flean. The current process then terminates.

If neither of the conditions prescribed in steps S204 and S214 is established, it is concluded that neither the maximum oxygen storage state nor the minimum oxygen storage state is reached. Therefore, step S222 is performed so that the target air-fuel ratio is maintained at the currently set air-fuel ratio. Step S212 is then performed to control the air-fuel ratio. The current process then terminates.

In the process described above, the oxygen storage capacity detection flag Xosc turns ON only when the element temperature of the first oxygen sensor 36 rises to the predetermined reference temperature (steps S60 to S64 in FIG. 11). Step S202 in FIG. 12 is then performed to judge whether the oxygen storage capacity detection flag Xosc is ON. Subsequent air-fuel ratio forced control is exercised only when the flag Xosc is ON. In other words, air-fuel ratio forced control and oxygen storage capacity detection operations do not start until the oxygen storage capacity detection flag Xosc turns ON. Therefore, when the above routine detects the oxygen storage capacity under air-fuel ratio forced control, the element temperature of the first oxygen sensor 36 is surely raised to the predetermined target temperature (between approximately 700° C. and 750° C.). Therefore, an output variation due to a variation in the element temperature of the first oxygen sensor 36 can be reduced to minimize the variation in the oxygen release period and oxygen storage period. As a result, the oxygen storage integrated amount can be detected during an appropriate period to accurately compute the oxygen storage capacity. Consequently, the system according to the third embodiment can detect the deterioration of the upstream catalyst with high accuracy.

It is assumed that the third embodiment detects the element impedance and calculates the element temperature. However, the present invention is not limited to the use of such a method. For example, the present invention may directly use the element impedance as a parameter. Another alternative would be to install a temperature sensor for element temperature detection, detect the element temperature directly with the installed temperature sensor, and use the detected element temperature as a parameter.

It is also assumed that the third embodiment exercises air-fuel ratio forced control in a conventional manner after the element temperature of the first oxygen sensor 36 rises to the reference temperature, and computes the oxygen storage integrated amount. However, the third embodiment is not limited to the use of such a method. For example, an alternative would be to combine the routine shown in FIG. 11 with the routine shown in FIG. 7, which is executed in the first embodiment, set the air-fuel ratio change amount ΔA/Fref for air-fuel ratio switchover in accordance with the intake air amount, and exercise control to gradually vary the air-fuel ratio until the target air-fuel ratio A/Flean, A/Frich is reached.

In the third embodiment, for example, performing steps S60 to S64 implements the “element temperature control means” according to the present invention, performing steps S302 and S212 implements the “rich air-fuel ratio control means,” and performing steps S304 and S212 implements the “lean air-fuel ratio control means.”

### Fourth Embodiment

The catalyst deterioration detection device according to a fourth embodiment of the present invention and a system surrounding the catalyst deterioration detection device have the same configuration as described in conjunction with the first embodiment (see FIG. 1). As is the case with the device according to the first embodiment, the device according to the fourth embodiment computes the oxygen storage capacity of the upstream catalyst 30 and judges the deterioration of the upstream catalyst in accordance with the oxygen storage capacity under air-fuel ratio forced control, which forcibly switches between a lean air-fuel ratio and a rich air-fuel ratio. The system according to the fourth embodiment is particularly characterized in that a lower-limit guard value is provided for the period of calculating the oxygen storage integrated amount.

FIG. 13 is a graph illustrating the output characteristic of the oxygen sensor. A solid line (c) indicates a deteriorated sensor output, whereas a dotted line (d) indicates an initial sensor output. In FIG. 13, the horizontal axis represents time, whereas the vertical axis represents an oxygen sensor output. The solid line (c) and dotted line (d) in FIG. 13 respectively indicate an output relative to the same exhaust gas.

As shown in FIG. 13, oxygen sensor output changes occurring before oxygen sensor deterioration differ from those occurring after oxygen sensor deterioration even when the oxygen sensor detects the same exhaust gas. It is believed that the oxygen sensor output changes mainly result from the deterioration of the oxygen sensor diffusion layer. The diffusion layer is formed on the surface of the exhaust side electrode and capable of governing and smoothing the exhaust gas near the exhaust side electrode before the exhaust gas reaches the exhaust side electrode. Therefore, when the deterioration of the diffusion layer progresses, the diffusion layer impairs its aforementioned capability of governing and smoothing the exhaust gas.

When the first oxygen sensor 36 is not deteriorated as indicated in FIG. 13, the exhaust gas reaching the surface of the exhaust side electrode is generally governed and smoothed by the diffusion layer. Therefore, the first oxygen sensor 36 generates an output that precisely represents the concentration of the exhaust gas during its concentration change, and exhibits a moderate response (dotted line (d)).

When, on the other hand, the first oxygen sensor is deteriorated, the diffusion layer does not adequately function so that the exhaust gas reaches the surface of the exhaust side electrode earlier than normal. Therefore, the deteriorated sensor exhibits a quick response and drastically changes its output in response to an exhaust gas concentration change from rich to lean (see solid line (c)).

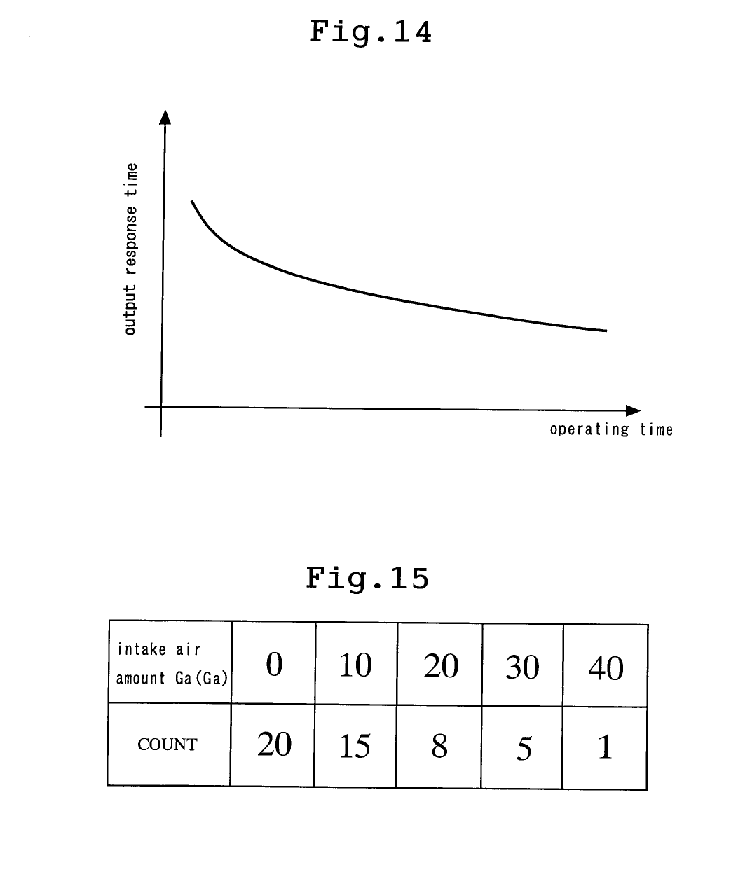

FIG. 14 shows the relationship between the operating time and output response time of the first oxygen sensor 36. In FIG. 14, the horizontal axis represents the operating time, whereas the vertical axis represents the output response time. FIG. 14 indicates that the output response time of the first oxygen sensor 36 gradually decreases with an increase in its operating time.

In the device according to the fourth embodiment, the first oxygen sensor 36, which is installed downstream of the upstream catalyst 30, detects a thin exhaust gas purified by the upstream catalyst 30. When a deteriorated oxygen sensor is used in such an exhaust gas, changes in the proportions of exhaust gas components, which arise due to the variation in the diffusion speed, greatly affect the sensor output. As a result, the sensor may generate a rich output at a lean stage or a lean output at a rich stage. Consequently, the maximum or minimum oxygen storage state may be prematurely detected. Thus, it is conceivable that the oxygen storage period or oxygen release period may vary.

In some cases, the lean output and rich output of the deteriorated first oxygen sensor 36 may be generated when slight component changes within the exhaust gas directly reach the exhaust side electrode without being governed by the diffusion layer. It is therefore conceivable that the timing with which the lean output and rich output are generated may greatly vary from one detection to another even when the same first oxygen sensor 36 is used. Thus, it is also conceivable that the oxygen storage period or oxygen release period may vary and become unduly short.

Under the above circumstances, the fourth embodiment prevents the oxygen storage period and oxygen release period, that is, an oxygen storage amount integration period, from becoming unduly short by providing a lower-limit guard for the oxygen storage amount integration period. More specifically, the fourth embodiment judges whether a period for allowing a sufficient amount of exhaust gas to flow into the upstream catalyst 30 and reach the maximum or minimum oxygen storage state has elapsed after the last detection of the minimum or maximum oxygen storage state. If the obtained judgment result does not indicate that a sufficient amount of exhaust gas has flowed into the upstream catalyst 30, the fourth embodiment does not immediately judge the maximum or minimum oxygen storage state even when the first oxygen sensor 36 generates a lean or rich output, but maintains the current air-fuel ratio and continuously computes the oxygen storage integrated amount until the period of exhaust gas inflow is found to be long enough.

In more concrete terms, the fourth embodiment sets up a counter integrated value COUNTsum that is to be incremented after the air-fuel ratio of the exhaust gas inflow to the upstream catalyst 30 switches to a rich or lean air-fuel ratio. While a predetermined reference value is not reached by the counter integrated value COUNTsum, the fourth embodiment prohibits the air-fuel ratio from switching to a rich or lean air-fuel ratio, maintains the current air-fuel ratio, and continues with oxygen storage amount integration.

The counter integrated value COUNTsum is obtained by adding up counter values COUNT according to the intake air amount Ga in accordance with Equation (4) below while a routine is repeatedly executed at predetermined time intervals in a situation where the counter integrated value COUNTsum is reset to zero when the exhaust gas existing upstream of the upstream catalyst 30 switches to a rich or lean air-fuel ratio.

Counter integrated value COUNTsum=previous counter integrated value COUNTsum+counter value COUNT (4)

FIG. 15 is a map illustrating the relationship between the intake air amount Ga and counter value. As shown in FIG. 15, the setting for the counter value COUNT decreases with an increase in the intake air amount Ga. As described in conjunction with the first embodiment, the response speed of the first oxygen sensor 36 increases when the intake air amount Ga is large. Therefore, when the intake air amount Ga is large, a lean or rich output may be generated earlier than normal to vary the oxygen release period or oxygen storage period. Consequently, setup is performed so that the counter value COUNT decreases with an increase in the intake air amount Ga to reduce the amount of increase in the counter integrated value COUNTsum. This increases the length of time required for the counter integrated value to reach the predetermined reference value. Thus, the resulting setup is such that the larger the intake air amount Ga, the longer the period of calculating the oxygen storage integrated amount.

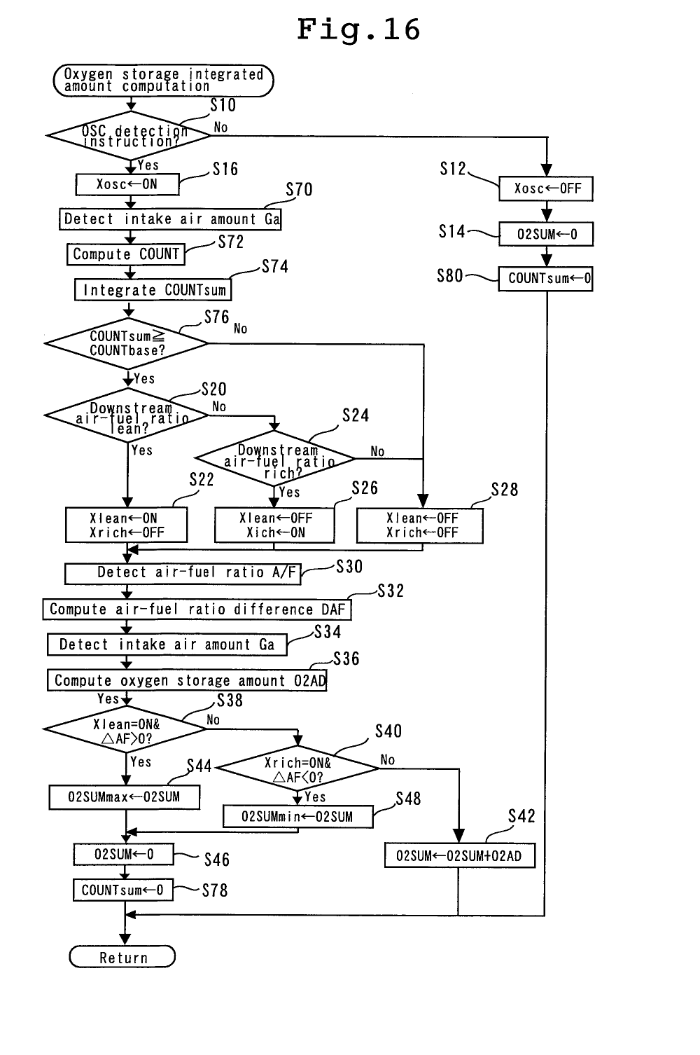

FIG. 16 is a flowchart illustrating a control routine that the ECU 40 executes in accordance with the fourth embodiment of the present invention. The routine shown in FIG. 16 is executed instead of the routine shown in FIG. 3, and similar to the routine shown in FIG. 3 except that it performs steps S70 to S76 after completion of step S16, performs step S78 after completion of step S42, and performs step S80 after completion of step S14.

When the oxygen storage amount detection flag turns ON in step S16, the routine shown in FIG. 16 first performs step S70 to detect the intake air amount Ga. The intake air amount Ga is detected in accordance with the output from the air flow meter 20. Next, step S72 is performed to compute the counter value COUNT. The counter value COUNT is determined from the map (see FIG. 15) stored in the ECU 40 in accordance with the intake air amount Ga.

Next, step S74 is performed to compute the counter integrated value COUNTsum. The counter integrated value COUNTsum is determined by adding the counter value COUNT computed in step S72 to the previously determined counter integrated value COUNTsum in accordance with Equation (4) above. This ensures that the counter integrated value COUNTsum is set in accordance with the intake air amount Ga and the elapsed time since the beginning of integration.

Next, step S76 is performed to judge whether the counter integrated value COUNTsum is not smaller than a reference counter value COUNTbase. If the obtained judgment result does not indicate that the counter integrated value COUNTsum≧reference counter value COUNTbase, step S28 is performed to turn OFF both the lean flag Xlean and rich flag Xrich. More specifically, both flags Xlean, Xrich are forcibly turned OFF without performing steps S20 and S24 to judge whether a lean or rich output is generated from the first oxygen sensor 36.

When the flags Xlean, Xrich are turned OFF, it is concluded that neither the maximum oxygen storage state nor the minimum oxygen storage state is reached. In the current routine, therefore, the queries in steps S38 and S40 are both answered “No.” Consequently, step S42 is performed to update the oxygen storage integrated amount O2SUM by adding the oxygen storage amount O2AD to the current oxygen storage integrated amount O2SUM. Subsequently, the current process terminates.

Further, as both flags Xlean, Xrich are turned OFF, air-fuel ratio forced control is exercised to maintain the current rich air-fuel ratio or lean air-fuel ratio without effecting air-fuel ratio switchover.

If, on the other hand, the judgment result obtained in step S76 indicates that the counter integrated value COUNTsum≧reference counter value COUNTbase, the routine proceeds to step S20 and exercises ON/OFF status control over the lean flag Xlean and rich flag Xrich in accordance with the output from the first oxygen sensor 36.

Subsequently, if the condition prescribed in step S38 or S40 is established, step S44 or S48 is performed to compute the maximum oxygen storage integrated amount SUMmax or minimum oxygen storage integrated amount SUMmin. When step S46 is subsequently performed to clear the oxygen storage integrated amount O2SUM to zero, step S78 is performed to clear the counter integrated value COUNTsum to zero as well. The current process then terminates.

If, on the other hand, the judgment result obtained in step S10 indicates that the oxygen storage capacity detection flag Xosc is OFF, step S80 is performed to clear the counter integrated value COUNTsum to zero after completion of step S14.

When the predetermined reference counter value COUNTbase is not reached by the counter integrated value COUNTsum, the fourth embodiment continuously exercises air-fuel ratio forced control to maintain the current target air-fuel ratio and updates the oxygen storage integrated amount O2SUM as described above without regard to the output from the first oxygen sensor 36. The counter value COUNTsum is set in accordance with the intake air amount Ga, and added to the counter integrated value COUNTsum while the routine is repeatedly executed at predetermined time intervals. Therefore, the counter integrated value COUNTsum is affected by the intake air amount Ga and the elapsed time since the last air-fuel ratio switchover.

Therefore, even when the first oxygen sensor 36 is deteriorated to increase the speed of response to an exhaust gas concentration change and vary the timing with which a lean output and rich output are generated, it is possible to avoid an undue decrease in the time required for actually reaching the maximum or minimum oxygen storage state. This makes it possible to prevent the output of the deteriorated first oxygen sensor 36 from prematurely judging the detection of the maximum or minimum oxygen storage state, thereby providing sufficient integration time.

The fourth embodiment assumes that the counter integrated value COUNTsum is based on the intake air amount. However, the present invention is not limited to the use of the counter integrated value COUNTsum. Alternatively, the present invention may permit air-fuel ratio switchover simply when a predetermined period of time elapses.

Further, the method used by the fourth embodiment to compute the counter integrated value COUNTsum and prohibit air-fuel ratio switchover before the counter integrated value COUNTsum reaches its reference value can be combined, for instance, with the deterioration detection method described in conjunction with the first to third embodiments.

In the fourth embodiment, for example, performing step S70 implements the “intake air amount detection means” according to the present invention, performing steps S72 and S74 implements the “integrated value computation means,” performing step S76 implements the “integrated value judgment means,” and performing step S28 implements the “air-fuel ratio switchover prohibition means.”

In the present invention, the internal combustion engine having the above-described catalyst deterioration detection device and the system around the internal combustion engine need not necessarily be configured as shown in FIG. 1. The internal combustion engine having the above-described catalyst deterioration detection device and the system around the internal combustion engine may be configured in an alternative manner without departing from the scope of the present invention. Even when the number, quantity, amount, range, or other numerical attribute of an element is mentioned in the above description of the embodiments, the present invention is not limited to the mentioned numerical attribute unless it is expressly stated or theoretically defined in principle. Further, structures and steps of methods described in conjunction with the embodiments are not necessarily essential to the present invention unless they are expressly stated or theoretically defined in principle.

1. A catalyst deterioration detection device comprising:
a catalyst which is positioned in an exhaust path of an internal combustion engine;
an oxygen sensor which is positioned downstream of the catalyst;
maximum oxygen storage state detection means which detects, in accordance with an output from the oxygen sensor, a maximum oxygen storage state where an exhaust gas outflowing downstream of the catalyst contains excess oxygen;
minimum oxygen storage state detection means which detects, in accordance with the output from the oxygen sensor, a minimum oxygen storage state where the exhaust gas outflowing downstream of the catalyst lacks oxygen;
rich air-fuel ratio control means which exercises control to provide a rich target air-fuel ratio for the internal combustion engine during an oxygen release period from the instant at which the maximum oxygen storage state is detected to the instant at which the minimum oxygen storage state is detected later;
lean air-fuel ratio control means which exercises control to provide a lean target air-fuel ratio for the internal combustion engine during an oxygen storage period from the instant at which the minimum oxygen storage state is detected to the instant at which the maximum oxygen storage state is detected later;
oxygen storage amount detection means which detects the amount of oxygen released from the catalyst during the oxygen release period or the amount of oxygen stored by the catalyst during the oxygen storage period as an oxygen storage amount;
catalyst deterioration judgment means which judges the deterioration of the catalyst in accordance with the oxygen storage amount; and
oxygen storage amount detection condition setup means which sets up oxygen storage amount detection conditions for correcting a variation that may occur in the oxygen release period or the oxygen storage period depending on a difference in output detection conditions for the oxygen sensor.

2. The catalyst deterioration detection device according to claim 1, further comprising:
intake air amount detector which detects the amount of intake air that is taken into the internal combustion engine;
wherein the oxygen storage amount detection condition setup means includes
change amount computation means which computes, in accordance with the intake air amount, an air-fuel ratio change amount that is required for changing the current air-fuel ratio to the rich target air-fuel ratio or the lean target air-fuel ratio when control is exercised during the oxygen release period or the oxygen storage period to change the air-fuel ratio of the internal combustion engine to the rich target air-fuel ratio or the lean target air-fuel ratio,
rich air-fuel ratio judgment means which judges, during the oxygen release period, whether a rich air-fuel ratio obtained by subtracting the air-fuel ratio change amount from the current target air-fuel ratio is greater than the rich target air-fuel ratio;
rich air-fuel ratio setup means which, when the rich air-fuel ratio is judged to be greater than the rich target air-fuel ratio, sets a target air-fuel ratio to the rich air-fuel ratio,
lean air-fuel ratio judgment means which judges, during the oxygen storage period, whether a lean air-fuel ratio obtained by adding the air-fuel ratio change amount to the current target air-fuel ratio is smaller than the lean target air-fuel ratio, and
lean air-fuel ratio setup means which, when the lean air-fuel ratio is judged to be smaller than the lean target air-fuel ratio, sets the target air-fuel ratio to the lean air-fuel ratio.

3. The catalyst deterioration detection device according to claim 1, further comprising:
element temperature detector for detecting an element temperature of the oxygen sensor;
wherein the oxygen storage amount detection condition setup means includes
rich target air-fuel ratio setup means for setting the rich target air-fuel ratio in accordance with the element temperature, and
lean target air-fuel ratio setup means for setting the lean target air-fuel ratio in accordance with the element temperature.

4. The catalyst deterioration detection device according to claim 3, wherein,
when the element temperature is higher, the rich target air-fuel ratio setup means sets a rich target air-fuel ratio that increases the difference between a stoichiometric air-fuel ratio and the rich target air-fuel ratio; and wherein,
when the element temperature is higher, the lean target air-fuel ratio setup means sets a lean target air-fuel ratio that increases the difference between the stoichiometric air-fuel ratio and the lean target air-fuel ratio.

5. The catalyst deterioration detection device according to claim 1, wherein the oxygen storage amount detection condition setup means includes element temperature control means which exercises control during the oxygen release period and the oxygen storage period so that the element temperature of the oxygen sensor agrees with a reference temperature higher than an activation temperature.

6. The catalyst deterioration detection device according to claim 5, wherein the reference temperature is between 700° C. and 750° C.

7. The catalyst deterioration detection device according to claim 1, further comprising:
integrated value computation means for computing an integrated value according to elapsed time since the beginning of the oxygen release period or an integrated value according to elapsed time since the beginning of the oxygen storage period;
integrated value judgment means for judging whether the integrated value is smaller than a reference value; and
air-fuel ratio switchover prohibition means which, when the integrated value is smaller than the reference value, prohibits an air-fuel ratio control from switching from the rich target air-fuel ratio to the lean target air-fuel ratio or switching from the lean target air-fuel ratio to the rich target air-fuel ratio.

8. The catalyst deterioration detection device according to claim 7, further comprising:
intake air amount detector for detecting the amount of intake air that is taken into the internal combustion engine;
wherein the integrated value computation means sets the integrated value in accordance with the elapsed time and the intake air amount.

9. The catalyst deterioration detection device according to claim 2, further comprising:
integrated value computation means for computing an integrated value according to elapsed time since the beginning of the oxygen release period or an integrated value according to elapsed time since the beginning of the oxygen storage period;
integrated value judgment means for judging whether the integrated value is smaller than a reference value; and
air-fuel ratio switchover prohibition means which, when the integrated value is smaller than the reference value, prohibits an air-fuel ratio control from switching from the rich target air-fuel ratio to the lean target air-fuel ratio or switching from the lean target air-fuel ratio to the rich target air-fuel ratio.

10. The catalyst deterioration detection device according to claim 3, further comprising:
integrated value computation means for computing an integrated value according to elapsed time since the beginning of the oxygen release period or an integrated value according to elapsed time since the beginning of the oxygen storage period;
integrated value judgment means for judging whether the integrated value is smaller than a reference value; and
air-fuel ratio switchover prohibition means which, when the integrated value is smaller than the reference value, prohibits an air-fuel ratio control from switching from the rich target air-fuel ratio to the lean target air-fuel ratio or switching from the lean target air-fuel ratio to the rich target air-fuel ratio.

11. The catalyst deterioration detection device according to claim 5, further comprising:
integrated value computation means for computing an integrated value according to elapsed time since the beginning of the oxygen release period or an integrated value according to elapsed time since the beginning of the oxygen storage period;
integrated value judgment means for judging whether the integrated value is smaller than a reference value; and
air-fuel ratio switchover prohibition means which, when the integrated value is smaller than the reference value, prohibits an air-fuel ratio control from switching from the rich target air-fuel ratio to the lean target air-fuel ratio or switching from the lean target air-fuel ratio to the rich target air-fuel ratio.

12. A catalyst deterioration detection device comprising:
a catalyst which is positioned in an exhaust path of an internal combustion engine;
an oxygen sensor which is positioned downstream of the catalyst;
maximum oxygen storage state detector which detects, in accordance with an output from the oxygen sensor, a maximum oxygen storage state where an exhaust gas outflowing downstream of the catalyst contains excess oxygen;
minimum oxygen storage state detector which detects, in accordance with the output from the oxygen sensor, a minimum oxygen storage state where the exhaust gas outflowing downstream of the catalyst lacks oxygen;
rich air-fuel ratio controller which exercises control to provide a rich target air-fuel ratio for the internal combustion engine during an oxygen release period from the instant at which the maximum oxygen storage state is detected to the instant at which the minimum oxygen storage state is detected later;
lean air-fuel ratio controller which exercises control to provide a lean target air-fuel ratio for the internal combustion engine during an oxygen storage period from the instant at which the minimum oxygen storage state is detected to the instant at which the maximum oxygen storage state is detected later;
oxygen storage amount detector which detects the amount of oxygen released from the catalyst during the oxygen release period or the amount of oxygen stored by the catalyst during the oxygen storage period as an oxygen storage amount;
catalyst deterioration judgment device which judges the deterioration of the catalyst in accordance with the oxygen storage amount; and
oxygen storage amount detection condition setup device which sets up oxygen storage amount detection conditions for correcting a variation that may occur in the oxygen release period or the oxygen storage period depending on a difference in output detection conditions for the oxygen sensor.
